(19) United States
(12) Patent Application Publication
(10) Pub. No.: US 2016/0114249 A1
(43) Pub. Date: Apr. 28, 2016

(54) AUGMENTED DIGITAL GAME SYSTEMS AND METHODS

(71) Applicant: FIRE OPAL MEDIA INC., Bellevue, WA (US)

(72) Inventor: Jay Leonard Schneider, Bellevue, WA (US)

(21) Appl. No.: 14/526,386

(22) Filed: Oct. 28, 2014

(51) Int. Cl. A63F 13/65

(52) U.S. Cl. CPC A63F 13/65

(57) ABSTRACT

An augmented digital game comprising a plurality of game rules, a plurality of game elements, and a plurality of game component objects each representing a different one of the game elements. The game is implemented at least in part by a computer-implemented method that associates an inactive power with a player of the game, and automatically assigns the inactive power to a selected one of the game component objects. This assignment may occur without any input from the player related to the assignment. The method also determines that an activation event has occurred, and activates the power after determining that the activation event has occurred. The activated power introduces at least one exception to the plurality of rules thereby modifying the game. The method also determines whether the player has won the modified game.

### BACKGROUND OF THE INVENTION

1. Field of the Invention

The present invention is directed generally to systems and methods that implement digital games.

2. Description of the Related Art

Digital games implemented both online and by gaming machines are a popular pastime and a significant source of revenue for both private and government entities. Further, digital games can be more complex than is possible with manually implemented games because a computing device is used to track status and direct game play. An ongoing need exists for new and improved systems and methods that implement digital games. The present application provides these and other advantages as will be apparent from the following detailed description and accompanying figures.

### BRIEF DESCRIPTION OF THE SEVERAL VIEWS OF THE DRAWING(S)

FIG. 1 is a schematic of a system that includes a plurality of client computing devices connected to a game system configured to implement a digital game to be played by one or more players.

FIG. 2 is a block diagram illustrating exemplary functional blocks or components implemented by the game system and the client computing devices of the system of FIG. 1.

FIG. 3A is a block diagram illustrating components of the digital game.

FIG. 3B is an illustration of an exemplary interactive graphical user interface as viewed by one of the players of the digital game.

FIG. 3C is an illustration of an exemplary visual representation of a game component object (e.g., an ace of diamonds playing card) including a visual indicator identifying a power associated with the game component object.

FIG. 3D is an illustration of the exemplary interactive graphical user interface of FIG. 3B after the occurrence of a “show all” event.

FIG. 4 is an exemplary format of a data structure that may be used to construct a game component object.

FIG. 5 is an exemplary format of a data structure that may be used to construct a power as a power object.

FIG. 6 is a flow diagram of a method of playing the digital game performed by the game system.

FIG. 7 is a flow diagram of a method performed by the game system during the playing of the game.

FIG. 8 is a flow diagram of a method of playing a hand of the digital game.

FIG. 9 is a flow diagram of a method of implementing a round of player turns and betting during a hand of the digital game.

FIG. 10 is a flow diagram of a method performed by the game system after hole cards have been dealt.

FIG. 11 is a flow diagram of a method that may be performed by the game system after community flop cards have been dealt.

FIG. 12 is a flow diagram of a method performed by the game system after a community turn card has been dealt.

FIG. 13 is a flow diagram of a method performed by the game system after a community river card has been dealt.

FIG. 14 is a flow diagram of a method performed by the game system after a “show all” event has occurred in the digital game.

FIG. 15 is a flow diagram of a method performed by the game system after a “showdown” event has occurred in the digital game.

FIG. 16 is a flow diagram of an alternate method of playing the digital game performed by the game system.

FIG. 17 is a flow diagram of an alternate method of playing a hand of the digital game.

FIG. 18 is a diagram of a hardware environment and an operating environment in which the computing devices of the system of FIG. 1 may be implemented.

### DETAILED DESCRIPTION OF THE INVENTION

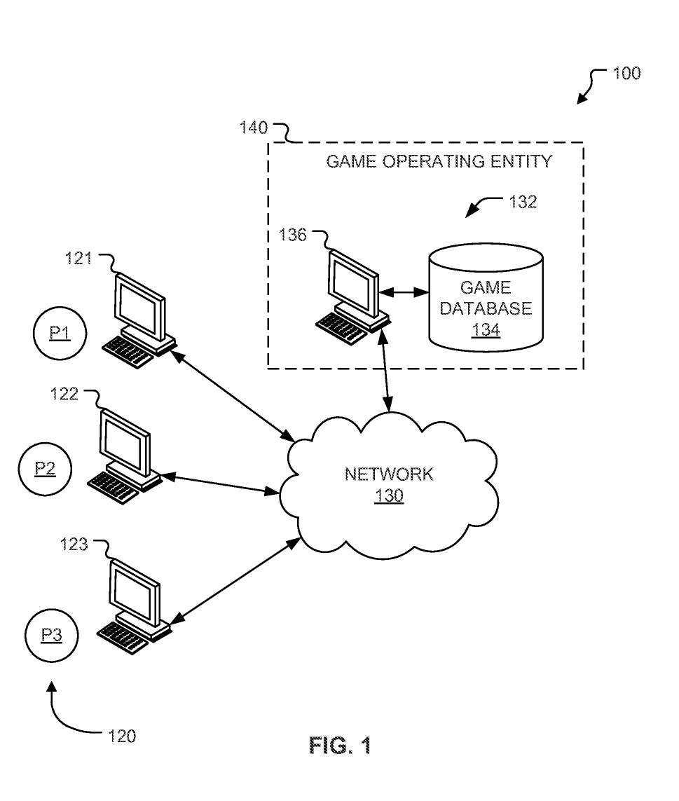

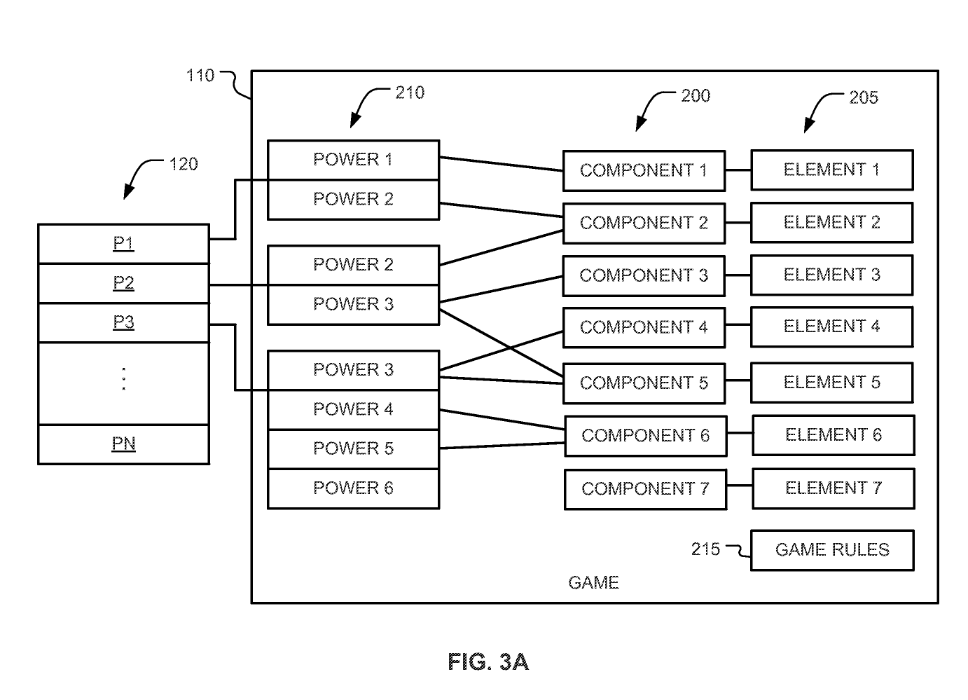

FIG. 1 is a schematic of a system 100 configured to implement a digital game 110 (see FIG. 3A) to be played by one or more players 120. The system 100 may be implemented by a plurality of computing devices connected together by a network 130 (e.g., the Internet) or by a single computing device or game machine (e.g., a video poker machine). The single computing device may be connected to a network (like the network 130) or may operate as a stand-alone device. In each implementation, the game 110 (see FIG. 3A) is implemented by one or more computing devices having software components executed by one or more processors.

As will be explained in detail below, the game 110 has a set of default rules (e.g., the rules of Texas hold'em) that are modified uniquely for each of the players 120. In other words, the game 110 is configured such that different rules apply to different players. Rule modifications are controlled by powers (described below) associated with the players 120. Thus, to play the game 110, player-to-power associations must be tracked. Not only are at least some of the powers associated with particular players, some of the powers are also associated with particular game elements (e.g., playing cards) represented by game component objects. These power-to-component associations are secret at first and later revealed to one or more players depending upon properties of the powers themselves. Thus, to play the game 110, player-to-power associations as well as power-to-component associations must be tracked. Further, when and what to reveal to whom must also be timed and tracked. Thus, the game 110 is too complex to implement other than with the use of one or more computing devices. In other words, managing the game 110 exceeds the capabilities of human beings and can only be accomplished by one or more computing devices.

Returning to FIG. 1, in the example illustrated, the players 120 include three players P1-P3. The players P1-P3 operate client computing devices 121-123, respectively. As is apparent to those of ordinary skill in the art, the game 110 (see FIG. 3A) may be played by the players 120 against one another, or by one or more of the players 120 against a game system 132. Further, any number of players operating any number of client computing devices may play the game 110 (see FIG. 3A).

The game system 132 is operated by a game operating entity 140, such as a casino, gaming company, government entity, and the like. The game system 132 includes at least one server computer device 136 and a game database 134. The server computer device 136 may include web server components (not shown) configured to transmit web pages to the client computing devices 121-123.

The game database 134 may be at least partially implemented by the server computer device 136. Optionally, the game database 134 may be at least partially implemented by one or more other computing devices (not shown) connected to the server computer device 136. While described as being a database, the game database 134 may be implemented by a technology other than a database configured to store game data.

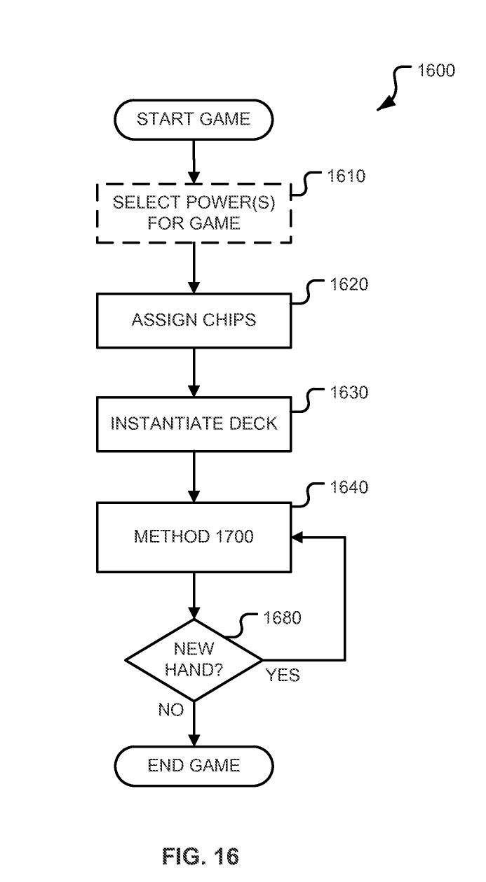

Each of the computing devices (e.g., the client computing devices 121-123 and the server computer device 136) of the system 100 may be implemented by a computing device 12 descripted below and illustrated in FIG. 16.

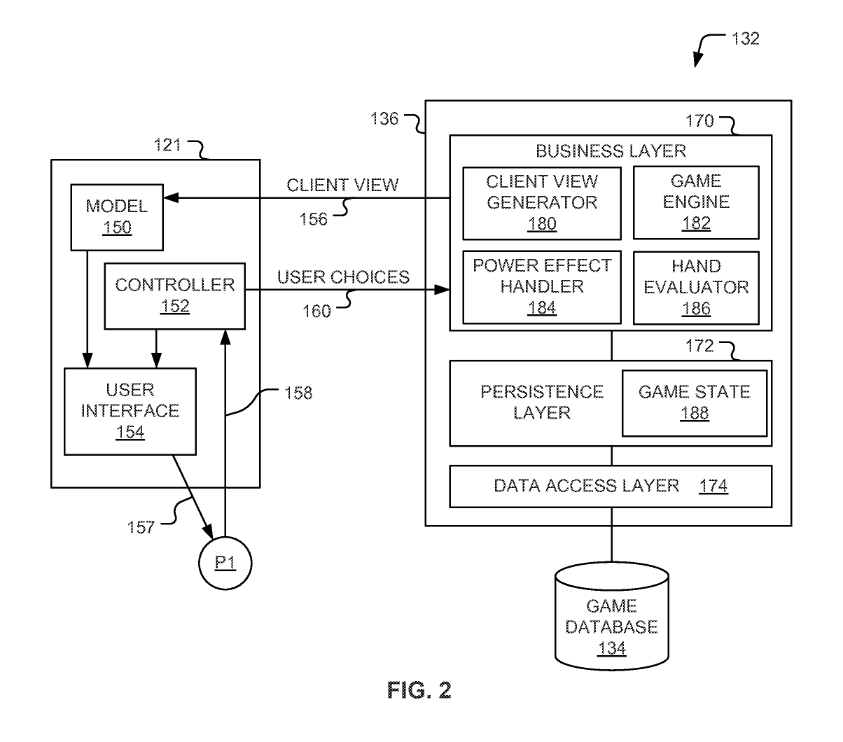

FIG. 2 is a block diagram illustrating exemplary functional blocks or components that may be implemented by the server computer device 136 and the client computing device 121 as well as interactions between those components. The components illustrated in FIG. 2 may be implemented by software, firmware, hardware, or a sub-combination or combination thereof.

Each of the client computing devices 122 and 123 may include components substantially similar to those described with respect to the client computing device 121. Further, such components may interact with the components implemented by the server computer device 136 in substantially the same manner that the components implemented by the client computing device 121 interact with the components implemented by the server computer device 136.

In the implementation illustrated, the exemplary components implemented by the client computing device 121 include a model 150, a controller 152, and a user interface 154. The model 150 receives client view instructions 156 from the server computer device 136 (over the network 130 illustrated in FIG. 1), and generates an interactive graphical user interface 157 (also depicted in FIGS. 3B and 3D) that is displayed to the player P1 by the user interface 154.

The player P1 interacts with the interactive graphical user interface 157, and inputs user selections 158 (e.g., selected powers, bet amounts, other decisions, such as fold, check, raise, or call, and the like) that are received by the controller 152. The controller 152 modifies the user interface 154 to reflect the user selections 158 and sends user choices 160 (based on the user selections 158) to the server computer device 136 (over the network 130 illustrated in FIG. 1).

In the implementation illustrated, the exemplary components implemented by the server computer device 136 implement a business layer 170, a persistence layer 172, and a data access layer 174. The business layer 170 includes a client view generator 180, a game engine 182, a power effect handler 184, and a hand evaluator 186. The client view generator 180 generates the client view instructions 156, and transmits them to the client computing device 121. The client view generator 180 may include the web server components (not shown). The game engine 182 receives the user choices 160 and uses them to implement and control the game 110. Further, the game engine 182 tracks game state information and uses it to instruct the client view generator 180 to generate appropriate client view instructions 156. The power effect handler 184 detects when a power has been activated (e.g., triggered) and effects whatever rule changes to the game 110 (see FIG. 3A) occur as a result of the activated power. The hand evaluator 186 determines which of the players 120 has won a particular hand.

The persistence layer 172 maintains game state information 188.

The data access layer 174 stores game data (e.g., the game state information 188) in the game database 134 and retrieves game data from the game database 134.

As mentioned above, the game engine 182 controls the game 110. FIG. 3A is a block diagram illustrating exemplary components of the digital game. For ease of illustration, in FIG. 3A, the players P1-P3 are illustrated as being arranged in an ascending order (based on a player identification number) from the player P1 to a player PN, and the powers are illustrated as being arranged in an ascending order (based on a power identifier 268 implemented as a numeric value) from a power “1” to a power “6.” However, this is not a requirement. For example, the player P3 could be using non-sequential powers (e.g., powers “1,” “3,” “4,” and “5”).

Referring to FIG. 3A, the game 110 may be implemented as a card game, such as poker. The game 110 includes a plurality of game elements 205 (such as cards) and a set or plurality of default game rules 215 (e.g., the rules of Texas hold'em).

The game 110 includes a plurality of game component objects 200 that each represents a different one of the plurality of game elements 205 (e.g., playing cards). The game 110 also includes a plurality of available powers 210. As mentioned above, the game 110 is augmented by associating one or more of the powers 210 with at least one of the players 120. In other words, at least one player-to-power association is established. In some embodiments, at least one of the powers 210 is associated with each of the players 120. Then, at least some of the powers 210 that have been associated with the players 120 are associated with one or more of the game component objects 200. In other words, at least one power-to-component association is established.

When first associated with the players 120, powers are inactive. When activated by an activating event, a power may change one or more of the plurality of rules 215 and/or transform a particular one of the plurality of elements 205 into a different one of the plurality of elements. Powers may be characterized as introducing at least one exception into the plurality of rules 215 of the game 110. When activated, a power may change or modify the game element represented by a particular game component object. For example, when activated, a power may transform a card representing the three of hearts into a card representing the king of diamonds. Further, the power may transform the card into a new card (e.g., a card having a rank greater than an ace). By way of another non-limiting example, the power may change the rule that a king outranks a queen to specify (for the player owning the power, or for all of the players) that a queen outranks a king. By way of yet another non-limiting example, a power may dictate that one or more particular game component objects be associated with the player owning the power. When the game 110 is a card game, such a power dictates that one or more particular card or cards are to be dealt to the player owning the power. As is apparent to those of ordinary skill in the art, a large number of rule changes and transforms may be implemented by the powers 210 and those described herein are provided for illustrative purposes and are not intended to be limiting.

Further, as mentioned above, managing the complexity of the player-to-power associations, power-to-component associations, rule changes, and timing necessitate a computer implementation. The game 110 is simply too complex to be implemented without the use of at least computing device. Additionally, a computer implementation is required because at least some of the powers 210 are randomly and secretly assigned to the game component objects 200, and (as will be described in more detail below) those power-to-component associations are revealed only to certain players and only at certain times.

Before the game 110 begins, each of the players 120 may choose which power(s) will be used during the game. Alternatively, each of the players 120 may be assigned one or more of the available powers 210. In the non-limiting example illustrated in FIG. 3A, the player P1 has selected “POWER 1” and “POWER 2,” the player P2 has selected “POWER 2” and “POWER 3,” and the player P3 has selected “POWER 3,” “POWER 4,” “POWER 5,” and “POWER 6.” The players 120 are not required to have the same number of powers. Powers selected or assigned to a particular player may be described as being owned by the particular player.

The game system 132 (see FIGS. 1 and 2) maintains a list of which of the powers 210 each of the players 120 owns. In other words, the game system 132 stores the player-to-power associations. As will be explained in detail below, some of the powers 210 may be assigned to or associated with eligible ones of the game component objects 200. When a power is activated or triggered, the power may provide some benefit to its owner. Depending upon the characteristics of the power, the power may be activated or triggered by the occurrence of an event with respect to the game component object 200 with which the power is associated. For example, a power associated with a game component object representing a card may be triggered when the card is drawn from the deck of playing cards. Each player's list of powers and their associated game component objects is independent of those of the other players.

As mentioned above, at least some of the powers owned by the players 120 are associated with one or more of the game component objects 200. The system 132 is configured to randomly and secretly assign such powers to eligible ones of the game component objects 200. In this example, “POWER 1” selected by the player P1 is associated with “COMPONENT 1.” “POWER 2” selected by the player P1 and “POWER 2” selected by the player P2 are both associated with “COMPONENT 2.” “POWER 3” selected by the player P2 is associated with “COMPONENT 3” and “COMPONENT 5.” “POWER 3” selected by the player P3 is associated with “COMPONENT 4” and “COMPONENT 5.” Both “POWER 4” and “POWER 5” selected by the player P3 are associated with “COMPONENT 6.” “POWER 6” is not associated with any of the game component objects 200. At least some of the game component objects 200 may not be associated with one of the available powers 210. For example, “COMPONENT 7” is not associated with a power.

While in FIG. 3A, only one of the components (“COMPONENT 7”) has not been associated with one of the powers, in alternate non-limiting examples, many of the components may be unassociated with the powers. For example, if the plurality of default game rules 215 are the rules of Texas hold'em, the game component objects 200 represent 52 cards in a standard deck and at least about 50% of them are unlikely to be associated with one of the powers 210.

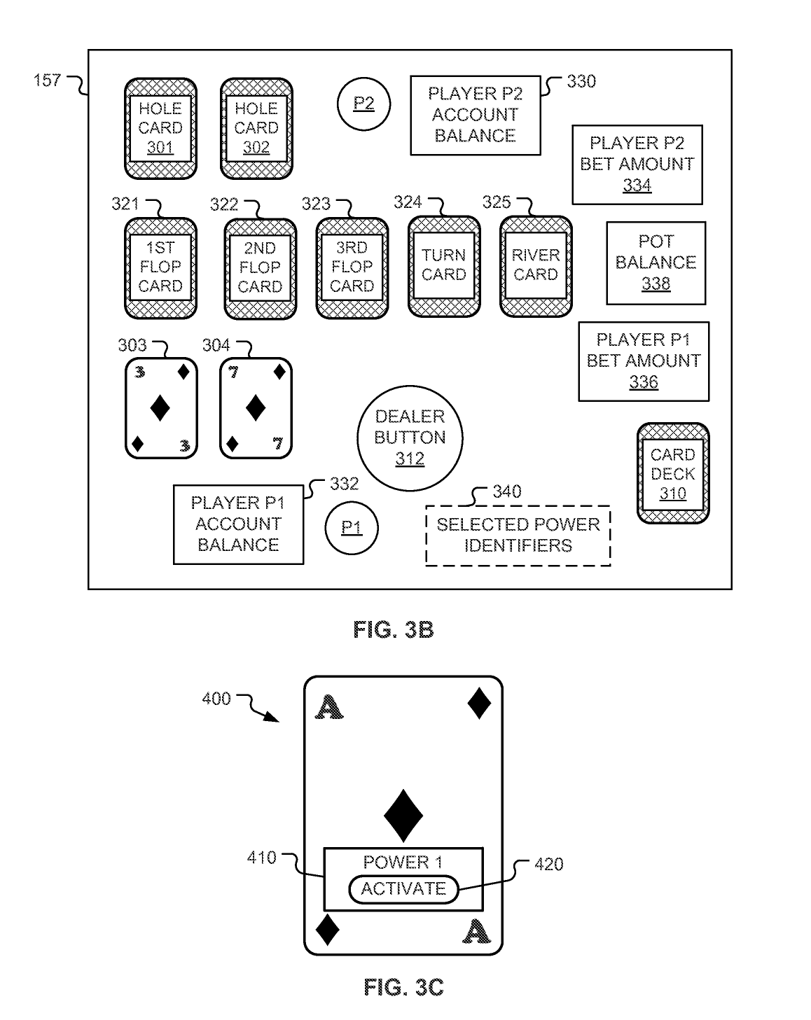

As mentioned above, if the game 110 is a conventional card game, (like poker), the game elements 205 are cards, and each card is represented by one of the game component objects 200. For example, “COMPONENT 1” may represent the ace of diamonds. FIG. 4 is a block diagram depicting an exemplary format 230 of a data object that may be used to construct each of the game component objects 200. Referring to FIG. 4, each of the game component objects 200 may have a component identifier 238, a type or rank identifier 240, a suit identifier 242, and one or more power field(s) 244. The component identifier 238 stores a value that uniquely identifies each of the components 200 (see FIG. 3A). By way of a non-limiting example, the component identifier 238 may store a numerical value.

The rank identifier 240 stores a rank value for the game component object. For example, if the game 110 is a card game, four of the game component objects 200 may have the value “ace” assigned as their rank identifiers 240. The suit identifier 242 indicates whether the game component object 200 is a heart, diamond, club, or spade.

The power fields 244 identify which of the available powers 210 is associated with the game component object 200. Each of the game component objects 200 may include a power field 244 for each of the players 120. For example, referring to FIG. 3A, the game component object representing the “COMPONENT 1” may have three power fields 244, one for each of the players P1-P3. The power field 244 for the player P1 will identify “POWER 1,” and the power fields 244 for the players P2 and P3 will be empty. Similarly, the “COMPONENT 5” may have three power fields 244, one for each of the players P1-P3. The power field 244 for the player P1 will be empty, the power field 244 for the player P2 will identify “POWER 3,” and the power field 244 for the player P3 will identify “POWER 3.” In embodiments in which each of the game component objects 200 has a power field for each of the players 120, the game engine 182 (see FIG. 2) may implement a rule that each game component object can be associated with at most one of the powers 210 owned by each of the players 120.

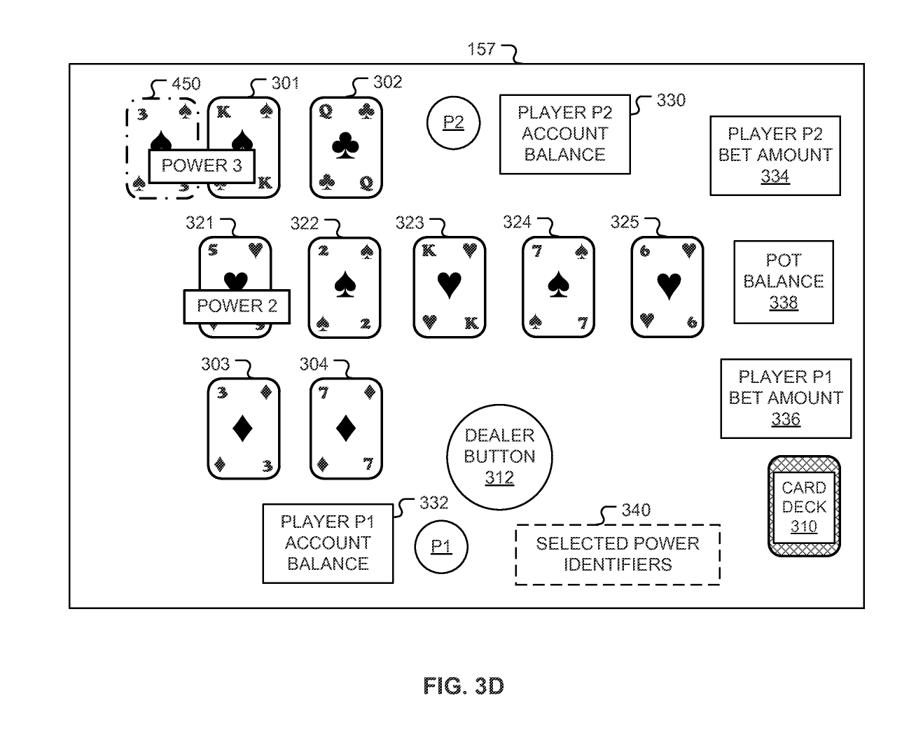

FIG. 5 is a block diagram depicting an exemplary format 260 of a data object that may be used to construct each of the powers 210 (see FIG. 3A) as a power object. Referring to FIG. 5, each of the powers 210 may have a power identifier 268, an effect indicator 270, an activation event identifier 272, a cost identifier 274, a player(s) aware indicator 276, a number of copies indicator 278, an activated indicator 280, one or more rules 282, a relevant event indicator 284, and an optional audio/visual effects identifier 286. The power identifier 268 stores a value that uniquely identifies each of the powers 210 (see FIG. 3A). By way of a non-limiting example, the power identifier 268 may store a numerical value.

The effect indicator 270 indicates what happens when the power is activated (e.g., triggered). For example, the power may transform its associated (or empowered) game component object for only its owner, and/or grant its owner some fixed (or predefined) reward. By way of another non-limiting example, the power may transform a different game component object for its owner and/or another player.

The activation event identifier 272 identified which action(s) and/or event(s) trigger or activate the power. For example, the power may be triggered automatically when its associated (or empowered) game component object enters play, or when the player who owns the power decides to manually activate the power (e.g., by clicking a visual indicator associated with the power) at some point thereafter.

The cost identifier 274 indicates how much of a player's total power capabilities the player would expend by selecting the power for use. For example, a player may be able to selected up to 100 units of powers. Each power specifies how many units are required to select (or purchase) the power. Depending upon the implementation details, powers may be selected (or purchased) at the beginning of the game 110 and/or during the game.

The player(s) aware indicator 276 indicates which if any players are aware of the power. The game engine 182 calculates and tracks the state of the game 110 at all times and provides only partial visual representations thereof (via the client view generator 180) to the players 120. FIG. 3B is an illustration of an exemplary implementation of the interactive graphical user interface 157 as it would appear to the player P1 at the start of a new hand, after the hole cards 301-304 have been dealt from a card deck 310, and before the first round of betting. In this example, the player P1 is the dealer (as indicated by a dealer button 312), and player P1 is playing against the player P2. For illustrative purposes, three flop cards 321-323, a turn card 324, and a river card 325 are depicted as having been dealt from the card deck 310 but not yet revealed. However, this need not occur before the first round of betting in the hand.

The interactive graphical user interface 157 includes account balance indicators 330 and 332 for the players P1 and P2, respectively, that show an amount available to each player to bet.

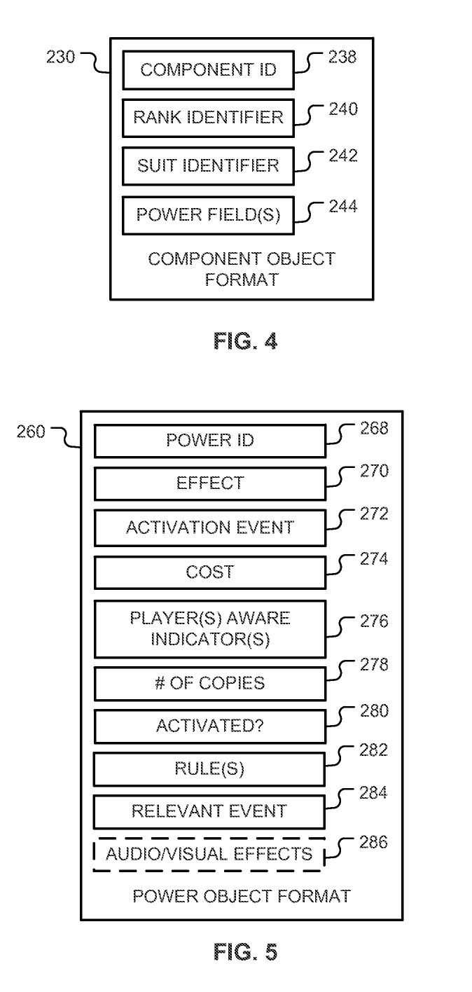

The interactive graphical user interface 157 includes bet amount indicators 334 and 336 for the players P1 and P2, respectively. The bet amount indicators 334 and 336 show a total amount bet by the players P1 and P2, respectively, during a round of betting (e.g., implemented by a method 900 depicted in FIG. 6). Below, the total amount bet by a player during a round of betting is referred to as a “previous bet amount.”

The interactive graphical user interface 157 includes a pot balance indicator 338 that shows how much has been bet in the hand.

Optionally, the interactive graphical user interface 157 includes one or more selected power identifiers 340 that are viewable by the player P1 and identify which powers have been selected by the player P1. Optionally, the one or more selected power identifiers 340 may also be viewable by the player P2. Optionally, the interactive graphical user interface 157 may include one or more selected power identifiers (like the selected power identifiers 340) that are viewable by the player P1 and identify which powers have been selected by the player P2.

In the embodiment illustrated, the player P1 cannot see any of the hole cards 301 and 302 dealt to the player P2. Similarly, the player P2 cannot see any of the hole cards 303 and 304 dealt to the player P1. Further, the player P1 cannot determine whether any of powers selected by the player P2 are associated with any of the hole cards 301 and 302 dealt to the player P2.

By default, before the hole cards 301-304 have been dealt, the view of the interactive graphical user interface 157 presented to the player P1 may not display any power association indicators and may not even include knowledge of which powers are present in the game 110. However, once a power associated with a card has been revealed to its owner, the game engine 182 (see FIG. 2) can continue to show that player the association from that point forward.

For example, FIG. 3C depicts a visual representation 400 of “COMPONENT 1” as viewed by the player P1. The visual representation 400 includes a visual indicator 410 identifying the “POWER 1” associated with the “COMPONENT 1.” However, if the “COMPONENT 1” had been dealt to a different player (e.g., the player P2) or is viewable by a different player, the visual representation 400 would not include the visual indicator 410 because only the player P1 owns the “POWER 1.”

In alternate embodiments, the game engine 182 may overlay the visual indicator 410 on top of a real world playing card via an augmented reality device (e.g., a telephone, a tablet, Google glass, and the like). In other words, the client computing devices 121-123 may implement an augmented reality system, in which the powers and their visibility to particular players are tracked by the system 132. In such embodiments, the client view generator 180 provides the client view instructions 156 to each player's individual augmented reality device to be overlaid onto the players' views of physical components (e.g., cards).

Returning to FIG. 5, the number of copies indicator 278 indicates how many copies of the power are available to the owner of the power. In alternate embodiments, the number of copies indicator 278 may indicate how many copies of the power are available for selection by the players 120 at the beginning of the game.

The activated indicator 280 indicates whether the power has been activated (e.g., by triggering).

The rule(s) 282 provide implementation details related to how and when the power may be activated. For example, the rules(2) 282 may include one or more restrictions as to with which type of game component objects the power may be associated. For example, the power may only be associated with game component objects having one or more particular ranks (e.g., ace) and/or suits (e.g., diamonds) as indicated by the rank and suit identifiers 240 and 242, respectively, of the game component objects 200. Alternatively, the power may be prohibited from being associated with one or more ranks (e.g., king) and/or suits (e.g., hearts) as indicated by the rank and suit identifiers 240 and 242, respectively, of the game component objects 200.

By way of another non-limiting example, the rule(s) 282 may define when the power's association with a particular game component object is revealed (or made visible) to its owner (the player who selected the power) and to other players (if any). For example, the power may be displayed to its owner when the game component object associated with the power becomes visible in the game 110 (e.g., “when dealt”). By way of another non-limiting example, when the plurality of default game rules 215 (see FIG. 3A) are the rules of Texas hold'em, the power may be displayed to other players when the poker hand is ready to be scored (e.g., after a “showdown” event has occurred).

By way of another non-limiting example, the rule(s) 282 may define a power priority or hierarchy that indicates what happens when an activation event activates more than one power at the same time. For example, the rule(s) 282 may give some powers higher priority than others.

The relevant event indicator 284 indicates when a power-to-component association is revealed to other players. In other words, the relevant event indicator 284 identifies a trigger event for revealing the association of a power with a game component object (e.g., representing a card) to the other players. By way of non-limiting examples, the relevant event indicator 284 may identify one of the following events: “when activated,” “show all,” “never,” and the like.

The game engine 182 may be configured to remember which power-to-component associations have already been displayed to each of the players, and continues to display that information to those players (e.g., using visual indicators like the visual indicator 410) on visual representations (like the visual representation 400) of such components. For example, in a first hand, the player P1 is dealt a card, a power is associated with that card, the power is made visible to the player P1 upon the occurrence of the “when dealt” event, and the power becomes visible to the other players P2 and P3 upon the occurrence of a “show all” event. In this example, after the card is dealt to the player P1 but before the occurrence of the “show all” event, the game engine 182 instructs the client view generator 180 to show the power-to-component association to only the player P1. However, after the occurrence of the “show all” event, the game engine 182 instructs the client view generator 180 to show the power-to-component association to the players P2 and P3. When a second hand 2 is played and the same card is both dealt and viewable by all of the players P1-P3, the power-to-component association is also displayed to all of the players P1-P3 because the game engine 182 knows that all of the players P1-P3 have already seen that association.

The optional audio/visual effects identifier 286 may identify what is displayed to the players P1-P3 when a power-to-component association is revealed and/or when the power is activated. By way of non-limiting examples, the audio/visual effects identifier 286 may contain information identifying sounds, images, animations, and the like displayed (or otherwise presented) to the players P1-P3 when the power is revealed and/or activated.

Referring to FIG. 3A, the powers 210 may be grouped into three categories based on the timing of their effects: (1) trigger powers, (2) activation powers, and (3) construction powers.

Trigger powers have an effect (generally mandatory), identified by the effect indicator 270, that occurs at some specified point after a game component object associated with the trigger power enters play in the game 110. Each trigger power is triggered by the occurrence of one or more of a plurality of trigger events. Thus, the activation event identifier 272 identifies the trigger event(s) that trigger the trigger power. Table A below provides non-limiting examples of trigger events.

TABLE A

| Trigger Event Name | Description |
|---|---|
| when dealt | directly following the game component object |
| | associated with the power entering play |
| showdown | when a hand is complete and about to be scored |
| show all | when betting has ended and at least one card in |
| | the hand has not yet been revealed |
| fifth card dealt | when the fifth community card (i.e., the river |
| | card) is dealt |
| bet | when a bet is placed |
| fold | when a player folds out of a hand |
| power triggered | when another power is triggered |

Additional examples of trigger events include when dealt into the community cards (e.g., the flop, the turn, or the river), when the river card is dealt, when a hand includes a pair (e.g., two cards having a rank of seven), and when a hand includes a four-card straight.

Optionally, the effect indicator 270 identifies a transformation with respect to any of the game component objects 200 associated with the power. Transform powers occur before non-transform powers triggered by the same event. Transform powers generally involve altering the rank and/or suit of a card and nothing else. Trigger powers may execute their effect (identified in the effect indicator 270) only once per hand unless the power specifies otherwise, but will refresh (and in most cases, reset any internal state) when a hand finishes.

Activation powers execute their effect (identified in the effect indicator 270) when activated manually by the power owning the power. Activation powers may execute their effect only once per hand unless the power specifies otherwise, but will refresh (and in most cases, reset any internal state) when a hand finishes. Unlike trigger powers, activation powers do not have an effect on their own. Instead, once an activation power is in play, its owner may choose to activate the activation power at any time its owner may perform actions (e.g., during the owner's turn in a hand), or as restricted by the activation power itself. In the digital game 110, this is accomplished by clicking on a visual indicator of the activation power attached to a visual representation of a game component object associated with the activation power. For example, referring to FIG. 3A, if “POWER 1” is an activation power, “POWER 1” may be activated by the player P1 by clicking on the visual indicator 410 (see FIG. 3C) included in the visual representation 400 (see FIG. 3C) of the “COMPONENT 1.” Optionally, referring to FIG. 3C, the visual indicator 410 may include a button 420 on which the player P1 may click to activate the “POWER 1.” Optionally, the button 420 may indicate the power has been activated (e.g., the button 420 may remain depressed, appear grayed out, and the like).

Construction powers (e.g., the “POWER 6” illustrated in FIG. 3A) are not associated with the game component objects 200 and simply take effect at the start of the game. Construction powers can be activated by the composition of powers a player has chosen. Further, construction powers can allow a player to break the rules of power selection. For example, a construction power may allow a player to play with more copies of a particular power than is normally permitted.

As explained above, powers may be characterized as introducing at least one exception into the default rules 215 of the digital game 110. For example, when activated, a power may dictate that one or more particular cards be dealt to the player that owns the power.

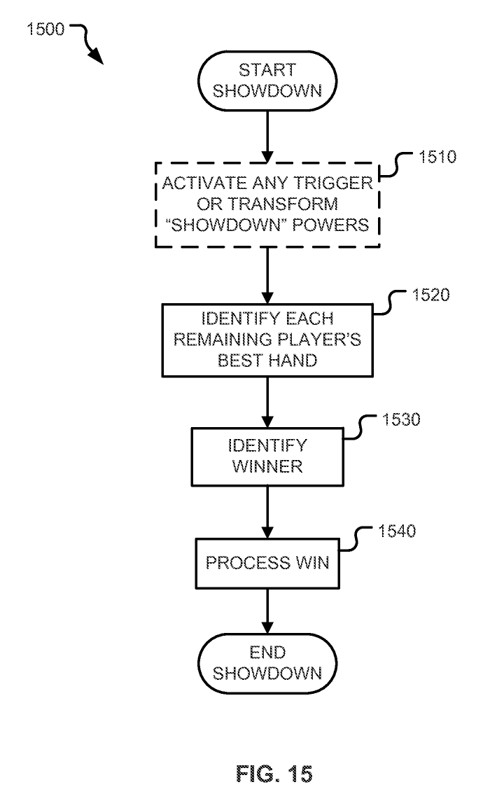

FIG. 3D depicts the interactive graphical user interface 157 as it would appear to the player P1 after a “show all” event has occurred. Thus, the hole cards 301-304, the flop cards 321-323, the turn card 324, and the river card 325 have been revealed to all of the players. Further, the “POWER 2,” which is associated with both of the players P1 and P2 as well as the flop card 321 has been revealed to both of the players P1 and P2. The “POWER 3,” associated with the hole card 301 and the player P2, has been revealed to the player P2. Further, in this example, the “POWER 3” has been revealed to the player P1 because in this example, the relevant event indicator 284 of the “POWER 3” indicates that the “POWER 3” is to be displayed to all of the players after a “show all” event occurs. However, the “POWER 3” was revealed only to the player P2 before the “show all” event occurred. In this example, the “POWER 3” is a transform power that transformed the three of spades (or “3 [symbol] ”) into the king of spades (or “K [symbol] ”) for the player P2. However, in this example, the three of spades remains the three of spades for the player P1, which would be important if the three spades was one of the community cards 321-325. A visual display 450 identifying the card (3 [symbol] ) that was transformed may be displayed next to the transformed hole card 301. Thus, the player P1 is able to see which card was transformed into the king of spades. As will be explained below, after the “show all” event, a “showdown” event occurs. After a “showdown” event occurs, the system 134 performs a method 1500 depicted in FIG. 15 to identify a winner of the hand.

FIGS. 6-15 are flow diagrams of methods of playing the digital game 110 performed by the game system 132. For ease of illustration, in the follow descriptions of these methods, the plurality of default game rules 215 (see FIG. 3A) are the rules of Texas hold'em. However, the rules of other games may be used. For example, the plurality of default game rules 215 may be the rules of other games that include a plurality of game elements (e.g., cards, tokens, game pieces, checkers, etc.) that may be represented by the game component objects 200. By way of non-limiting examples, the plurality of default game rules 215 may be the rules of other card games (e.g., Solitaire, Five Card Stud, Black Jack, Memory, Spades, Rummy, Gin Rummy, Hearts, Euchre, etc.), casino games (e.g., roulette, craps, slots, etc.), Bingo, board games (such as Monopoly, Life, Sorry, checkers, chess, etc.), dominos, and the like.

In an embodiment in which the plurality of default game rules 215 are the rules of roulette, each of the game component objects 200 represents (or is associated with) a different one of the squares on the table and the roulette wheel. In an embodiment in which the plurality of default game rules 215 are the rules of craps, each of the game component objects 200 represents (or is associated with) one of the faces of one of the dies. In an embodiment in which the plurality of default game rules 215 are the rules of slots, each of the game component objects 200 represents (or is associated with) one value on one of the wheels. Powers appropriate to each of these games may be defined and associated with the game component objects 200.

FIG. 6 is a flow diagram of a method 600 performed by the system 132 (see FIG. 1). In decision block 620, the system 132 determines whether the players 120 will be selecting any powers or using predetermined, previously selected, or default powers.

The decision in decision block 620 is “YES” when the system 132 determines the players 120 will be selecting powers. Otherwise, the decision in decision block 620 is “NO.”

When the decision in decision block 620 is “NO,” the system 132 advances to block 665.

On the other hand, when the decision in decision block 620 is “YES,” the system 132 advances to optional block 630. In implementations in which the optional block 630 is omitted, the system 132 advances to block 640 instead.

In optional block 630, the system 132 identifies for which powers each of the players 120 is eligible.

In block 640, the system 132 instructs the client computing devices 121-123 to display powers to the players 120 from which the players 120 may make selections.

After the client computing devices 121-123 display the powers to the players 120 (e.g., via the user interface 154 depicted in FIG. 2), the players 120 may select powers to use during the game. Optionally, each power may have a specified cost (e.g., a whole number greater than zero). The players 120 may have a limited budget (e.g., 52) to spend on powers. Further, each power may have a limit as to how many of times that particular power may be selected (e.g., from one to three times) by each of the players 120.

Alternatively, each of the players 120 may select up to a predetermined number of powers (e.g., five powers). In such embodiments, the number of copies indicator 278 (see FIG. 5) of each power may specify how many copies of the power the player receives (e.g., from one to three copies). The first method of selecting powers allows more variety in power value, and provides more player choice, while the second method has the virtue of being simpler.

In both methods, an additional parameter, namely probability of appearance of the power given appearance of its associated game component object, may be used. For example, a particularly desirable power may be configured such that the power is activated only about 40% of the time that the power appears in the game 110. This allows for precise adjustment of the values (and/or costs) of different powers.

Limitations may be placed on from which powers each of the players 120 may select. For example, the game 110 may include a system of power ownership in which each player must earn, purchase, or be granted access to one or more of the powers 210 before the player can select such powers.

In block 650, the system 132 receives user selections and, in block 660, the system 132 associates each selection with the appropriate player. The powers selected by the players 120 may be displayed as selected power identifiers (e.g., the one or more selected power identifiers 340 depicted in FIG. 3B).

Returning to FIG. 6, in optional block 665, the system 132 activates construction powers. Referring to FIG. 2, the power effect handler 184 may activate any such powers and implement their effects.

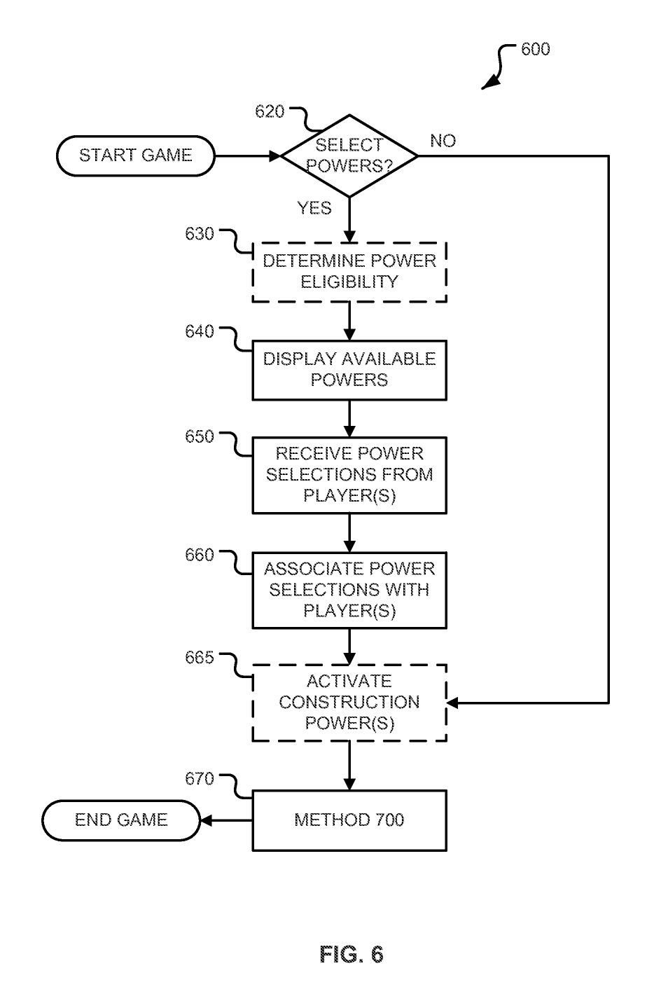

Returning to FIG. 6, the system 132 advances to block 670 and performs a method 700 depicted in FIG. 7.

After block 670, the method 600 terminates.

FIG. 7 is a flow diagram of the method 700 performed by the system 132. In first block 710, the system 132 assigns an amount of money or quantity of chips to each of the players 120 to use to place bets during the game. For ease of illustration, the amount assigned to each of the players 120 will be described as being stored in an account associated with (or owned by) the player. The amounts stored in the accounts may be displayed to the players 120 in account balance indicators 330 and 332 (e.g., the account balance indicators 330 and 332 depicted in FIG. 3B).

In block 720, the system 132 instantiates the card deck 310 (see FIG. 3B) of cards. As is apparent to those of ordinary skill in the art, a standard deck of playing cards includes 52 playing cards. The deck includes cards having the following ranks in ascending order: 2, 3, 4, 5, 6, 7, 8, 9, 10, jack, queen, king, and ace. The deck includes cards having four suits: diamonds, hearts, clubs, and spades. The deck includes a different card for each of the 13 ranks in each of the four suits for a total of 52 cards.

In next block 730, the system 132 orders the players 120.

Then, in block 740, the system 132 selects a player in accordance with the order determined in block 730.

In block 750, the system 132 assigns the powers associated with the player selected in block 740 to at least some of the game component objects 200 (e.g., cards). By way of a non-limiting example, the system 132 may assign the powers to at least some of the game component objects 200 in the following manner:
1) Determine how many game component objects 200 are eligible for association with each power (according to the power's restrictions, e.g., specified in the rule(s) 282 depicted in FIG. 5) owned by the player selected in block 740;
2) Sort the powers owned by the player selected in block 740 by the number of the game component objects 200 eligible for association with each of the powers (e.g., from most constrained (or smallest number eligible) to least constrained (or largest number eligible)) to obtain a sorted list of powers.
3) Resolve ties (e.g., in a deterministic, arbitrary manner) in the sorted list of powers. By way of a non-limiting example, powers having identical numbers of the game component objects 200 eligible for association with each of the powers may be ordered by the values of their power identifiers 268 (see FIG. 5).
4) Order the game component objects 200 (e.g., randomly) to create an ordered list.
5) Select the first power in the sorted list of powers, and identify a first one of the game component objects 200 in the ordered list eligible for association with the power.
6) If no match is found, the power is not associated with a game component object at this time, and the first power is removed from the sorted list of powers.
7) If a match was found:
   i) associate the power with the identified game component object,
   ii) if the identified game component object cannot be associated with another power owned by the same player, remove the identified game component object from the ordered list of game component objects;
   iii) if the power cannot be associated with another game component object, remove the power from the sorted list of powers,
   iv) if the power can be associated with another game component object and the identified game component object has not been removed from the ordered list of game component objects, identify the identified game component object as ineligible for duplicate associations of the power with the identified game component object, and.
8) Repeat steps 5-7 until all of the powers in the sorted list of powers have been processed.

Then, in decision block 760, the system 132 determines whether all of the players 120 have been selected. The decision in decision block 760 is “YES” when the system 132 determines all of the players 120 have been selected. Otherwise, the decision in decision block 760 is “NO.”

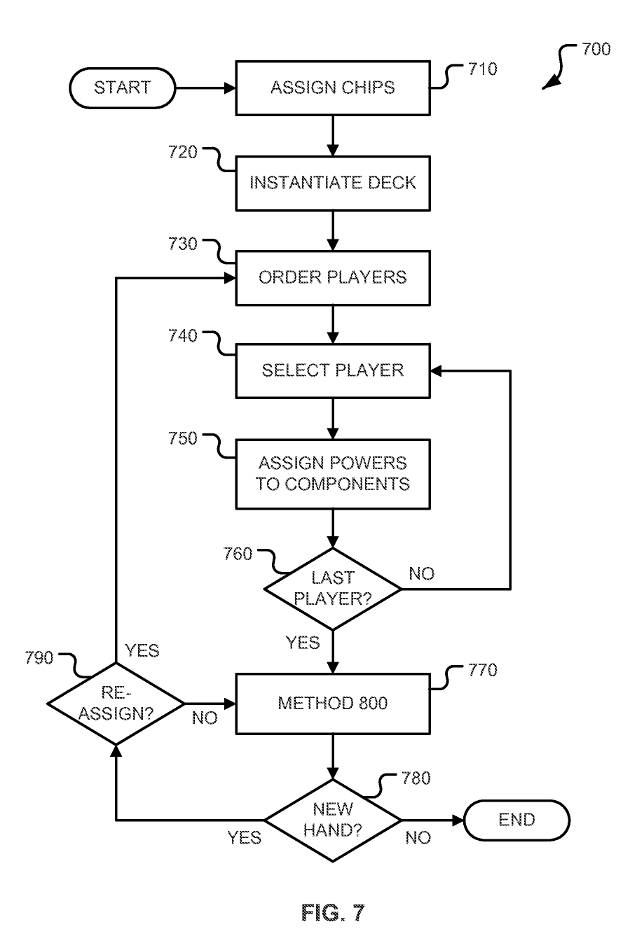

When the decision in decision block 760 is “NO,” the system 132 returns to block 740 and selects a next player in accordance with the order determined in block 730. On the other hand, when the decision in decision block 760 is “YES,” the system 132 advances to block 770 and performs a method 800 depicted in FIG. 8. The method 800 implements a hand of the game.

After block 770, in decision block 780, the system 132 determines whether the players 120 would like to play another hand of the game. The decision in decision block 780 is “YES” when the system 132 determines at least some of the players 120 would like to play another hand of the game. On the other hand, the decision in decision block 780 is “NO” when the system 132 determines the players 120 would not like to play another hand of the game.

When the decision in decision block 780 is “YES,” the system 132 advanced to decision block 790. In decision block 790, the system 132 determines whether to reassign the powers to the game component objects. Before the first hand is played, each of the players 120 knows which powers they have selected, but does not know to which of the game component objects 200 those powers have been associated. As the player plays the game 110 and those of the game component objects 200 with associated powers are revealed, the player will gain knowledge of these associations. After some predetermined, possibly somewhat randomized amount of gameplay, the game system 132 may automatically reassign (or re-randomize) the associations of powers with the game component objects 200, effectively eliminating each player's knowledge of those associations. At least some of the players 120 may enjoy discovering which powers have been associated with which of the game component objects 200.

The decision in decision block 790 is “YES,” when the system 132 decides to reassign the powers to the game component objects. When the decision in decision in decision block 790 is “YES,” the system 132 returns to block 730.

On the other hand, the decision in decision block 790 is “NO,” when the system 132 decides not to reassign the powers to the game component objects. When the decision in decision block 790 is “NO,” the system 132 returns to block 770.

When the decision in decision block 780 is “NO,” the method 700 terminates.

FIG. 8 is a flow diagram of the method 800 performed by the system 132. In first block 810, the system 132 selects one of the players 120 as the dealer, optionally displays the dealer button 312 (see FIG. 3B) next to a visual representation associated with the player selected as the dealer, shuffles the cards in the deck 310 (see FIG. 3B), and deals two hole cards to each player. The hole cards are displayed only to the player to which the hole cards have been dealt. As illustrated in FIG. 3B, each of the hole cards 301-304 is displayed as a visual representation of the game component object representing the card. For example, in FIG. 3B, the hole cards 303 and 304 have been dealt to the player P1, and the hole cards 301 and 302 have been dealt to the player P2. Because FIG. 3B is the view presented to the player P1, only the hole cards 303 and 304 dealt to the player P1 are revealed.

Returning to FIG. 8, in decision block 820, the system 132 determines (a) whether any of the cards dealt in block 810 had powers assigned to them in block 750 of the method 700 illustrated in FIG. 7, and (b) for each of those powers, whether the power belongs to the player to whom the card associated with the power was dealt.

Returning to FIG. 8, the decision in decision block 820 is “YES” when the system 132 determines (a) one or more of the cards dealt in block 810 had powers assigned to them, and (b) at least one of those powers belongs to the player to whom the card associated with the power was dealt. Otherwise, the decision in decision block 820 is “NO.”

In general, a power associated with a hole card triggers only if the power belongs to the player to whom the hole card was dealt. In other words, powers trigger only if they are associated with cards that are part of a player's hand.

When the decision in decision block 820 is “YES,” in block 830, the system 132 reveals the power to the player who owns the power and was dealt the card associated with the power. For example, any powers associated with one of the hole cards may be identified by a visual indicator (e.g., the visual indicator 410 depicted in FIG. 3C) displayed to the player indicating that a power is associated with the game component object representing the card.

The system 132 activates any powers triggered by a “when dealt” event and/or performs any transforms that occur after a “when dealt” event. Referring to FIG. 2, the power effect handler 184 may activate any such powers and implement their effects. Returning to FIG. 8, the system 132 advances to block 840.

When the decision in decision block 820 is “NO,” the system 132 advances to block 840.

In block 840, the system 132 subtracts a small blind amount from the player to the left of the dealer, and subtracts a big blind amount from the player to the left of the player from which the small blind amount was subtracted. Both the small and big blind amounts are added to the pot and the pot balance indicator 338 (see FIG. 3B) is updated. If the player from which the small blind amount is to be subtracted has an account balance that is less than the small blind amount, that player is forced to go “all in.” Similarly, if the player from which the big blind amount is to be subtracted has an account balance that is less than the big blind amount, that player is forced to go “all in.”

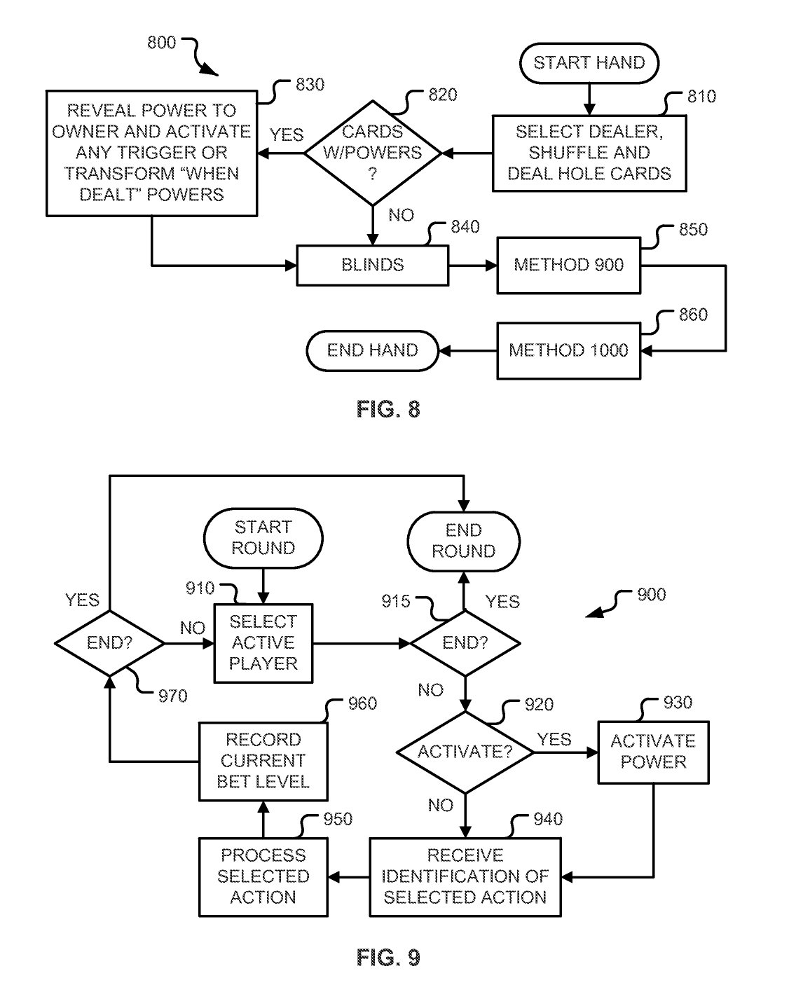

Then, in block 850, the system 132 performs the method 900 illustrated in FIG. 9. The method 900 implements the turns taken by the players 120, which include a round of betting.

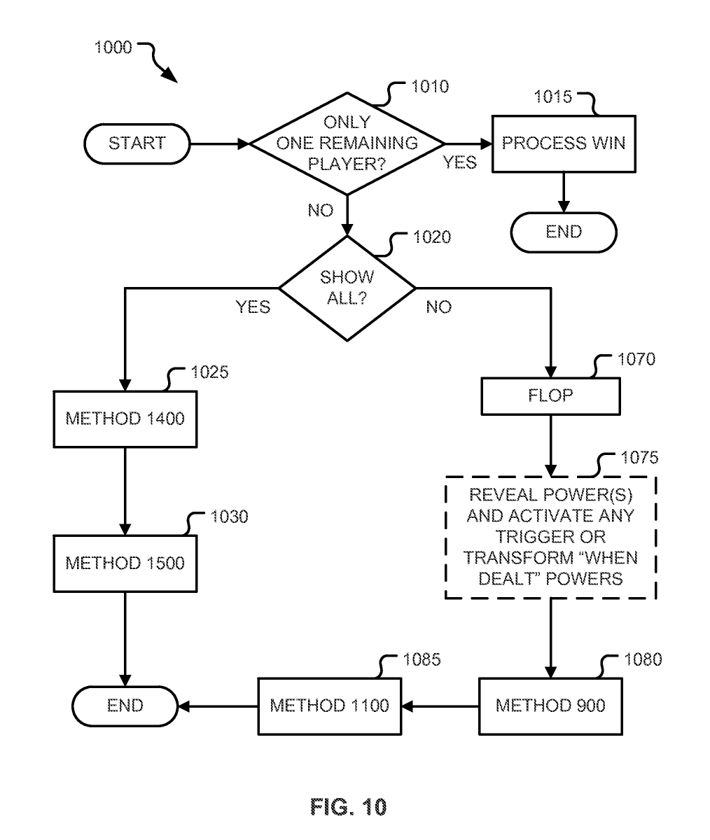

Returning to FIG. 8, after block 850, the system 132 advances to block 860 and performs a method 1000 illustrated in FIG. 10. Returning to FIG. 8, after block 860, the method 800 terminates and the hand ends.

FIG. 9 is a flow diagram of the method 900 performed by the system 132. In first block 910, the system 132 selects one of the players 120 as an active player. The active player is the player whose turn it is presently. By way of a non-limiting example, at the start of the method 900 (which is the first time block 910 is performed), the system 132 may select, as the active player, the player to the left of the player who paid the big blind. Further, the next time block 910 is performed, the system 132 may select, as the active player, the player to the left of the player selected previously. If a player is no longer in the hand, that player may be skipped and the player to the left of the skipped player may be selected as the active player.

At the start of the method 900 (which is the first time block 910 is performed), a current bet level may be set to a maximum previous bet amount. As noted above, two involuntary bets, the small and bid blind amounts may have been added to the pot balance 338 (see FIG. 3B). However, if at least one of the players from which the small and big blind amounts are to be collected has an insufficient account balance, less than the small or big blind amount may have been collected and added to the pot balance 338. When this occurs, the maximum previous bet amount is set equal to the greater of the amount collected from each of the players required to bet the small and big blind amounts. Whenever, a player successfully bets a bet amount that is greater than the current bet level, the current bet level is increased to that bet amount.

As is apparent to those familiar with the game of Texas hold'em, a player may have more than one turn each time the system 132 performs the method 900. In other words, a round of betting (implemented by the method 900) may include one or more turns for each of the players. Thus, the player may have bet previously during a single round of betting. Any bets made by the player during the same round of betting are totaled (and displayed by the appropriate one of the bet amount indicators 334 and 336 illustrated in FIG. 3B). As mentioned above, this total is referred to below as the previous bet amount. Further, the current bet level may change during the round of betting. Thus, each time a player completes a turn, the system 132 may record the current bet level as a previous bet level for the player.

Returning to FIG. 9, after block 910, the system 132 advances to decision block 915. In decision block 915 the system decides whether to end the round of betting. As mentioned above, the active player may have been selected as the active player previously during the round. The decision in decision block 915 is “YES” when the active player was selected as the active player previously during the round of betting and the current bet level is equal to the previous bet level for the player. When the decision in decision block 915 is “YES,” the method 900 terminates.

On the other hand, the decision in decision block 915 is “NO” when the active player was not selected previously during the round of betting as the active player. The decision in decision block 915 is also “NO” when the active player was selected as the active player previously during the round of betting and the current bet level is not equal to the previous bet level for the player. When the decision in decision block 915 is “NO,” the system 132 advances to decision block 920.

In decision block 920, the system 132 determines whether the active player would like to activate one or more activation powers. The active player has the option to activate any activation powers associated with the active player and a game component object in play that is eligible for activation. As explained above, powers may be displayed graphically to their owner by overlaying visual indicators (e.g., the visual indicator 410) over visual representations (e.g., the visual representation 400) of the game component objects with which the powers are associated. Unused activation powers may additionally indicate the fact that such powers have not yet been used with button visuals. For example, referring to FIG. 3C, the button 420 may be depressed to activate the “POWER 1” and may indicate whether the “POWER 1” has been activated (e.g., by remaining depressed, appearing grayed out, and the like). In some implementations, a player does not know about an association between a game component object and a power until the player views a visual representation (e.g., the visual representation 400) of the game component object with the visual indicator (e.g., the visual indicator 410) identifying the associated power during the game.

Returning to FIG. 9, the decision in decision block 920 is “YES” when the system 132 determines the active player would like to activate one or more activation powers. Otherwise, the decision in decision block 920 is “NO.”

When the decision in decision block 920 is “YES,” in block 930, the system 132 activates the one or more activation powers selected for activation by the player. Then, the system 132 advances to block 940.

When the decision in decision block 920 is “NO,” the system 132 advances to block 940.

In block 940, the system 132 receives an identification of an action selected by the active player. Exemplary actions available to the player include check, raise, fold, and call.

In block 950, the system 132 processes the player's selection of check, raise, fold, or call. If the player selected check, the system 132 determines whether the player's previous bet amount is equal to the current bet level. If the player's previous bet amount is less than the current bet level, the system 132 notifies the player that he/she cannot check and must make another selection. Then, the system 132 waits until it receives a new selection of raise, fold, and call from the active player.

If the player selected raise, the system 132 receives a new bet amount from the player, confirms that the new bet amount is greater than the current bet level, increases the current bet level to be equal to the new bet amount, increases the player's previous bet amount to be equal to the new bet amount, subtracts the amount of this increase from the player's account (and updates an appropriate one of the account balance indicators 330 and 332 illustrated in FIG. 3B), and adds the amount of that increase to the pot (and updates the pot balance indicator illustrated in FIG. 3B).

If the player selected fold, the system 132 identifies the player as no longer being in the hand.

If the player selected call, the system 132 determines a difference between the current bet level and the player's previous bet amount, subtracts the difference from the player's account (and updates an appropriate one of the account balance indicators 330 and 332 illustrated in FIG. 3B), adds the difference to the player's previous bet amount, and adds the difference to the pot (and updates the pot balance indicator illustrated in FIG. 3B).

If the player selected raise or call, and after the system 132 processes the selection, the player's account is empty (i.e., has a balance of zero), the player is referred to as being “all in.”

At this point, the active player's turn is over. In block 960, the system 132 records the current bet level as the previous bet level for the active player whose turn has just ended.

Then, the system 132 advances to decision block 970. In decision block 970, the system 132 decides whether to end the round of betting. The decision in decision block 970 is “YES,” when a) only one player remains in the hand who is not “all in,” and b) all of the players remaining in the hand are either “all in”, or the previous bet level of each of these players is equal to the current bet level. Otherwise, the decision in decision block 970 is “NO.”

When the decision in decision block 970 is “NO,” the system 132 returns to block 910.

On the other hand, when the decision in decision block 970 is “YES,” the method 900 terminates.

FIG. 10 is a flow diagram of the method 1000 performed by the system 132 after the hole cards (e.g., the hole cards 301-304 illustrated in FIG. 3B) have been dealt and the method 900 has been performed for the first time in the hand. In decision block 1010, the system 132 determines whether only a single player remains in the hand.

The decision in decision block 1010 is “YES” when the system 132 determines only a single player remains in the hand. This occurs when all of the players except one have indicated in block 940 of the method 900 (see FIG. 9) that they have decided to fold. The decision in decision block 1010 is “NO” when the system 132 determines more than one player remains in the hand.

When the decision in decision block 1010 is “YES,” in block 1015, the system 132 determines the remaining player is the winner and awards the winner the funds stored in the pot. Then, the method 1000 terminates.

On the other hand, when the decision in decision block 1010 is “NO,” the system 132 advances to decision block 1020. In decision block 1020, the system 132 determines whether the hole cards should be shown to all of the players 120. The decision in decision block 1020 is “YES” when the system 132 determines the hole cards should be shown to all of the players 120. This occurs when all of the remaining players except at most one are “all in.” In other words, no more betting can occur. The decision in decision block 1020 is “NO” when the system 132 determines the hole cards should not be shown to all of the players 120. This occurs when two or more of the remaining players are not “all in” and, therefore, more betting (e.g., in a side pot) can occur.

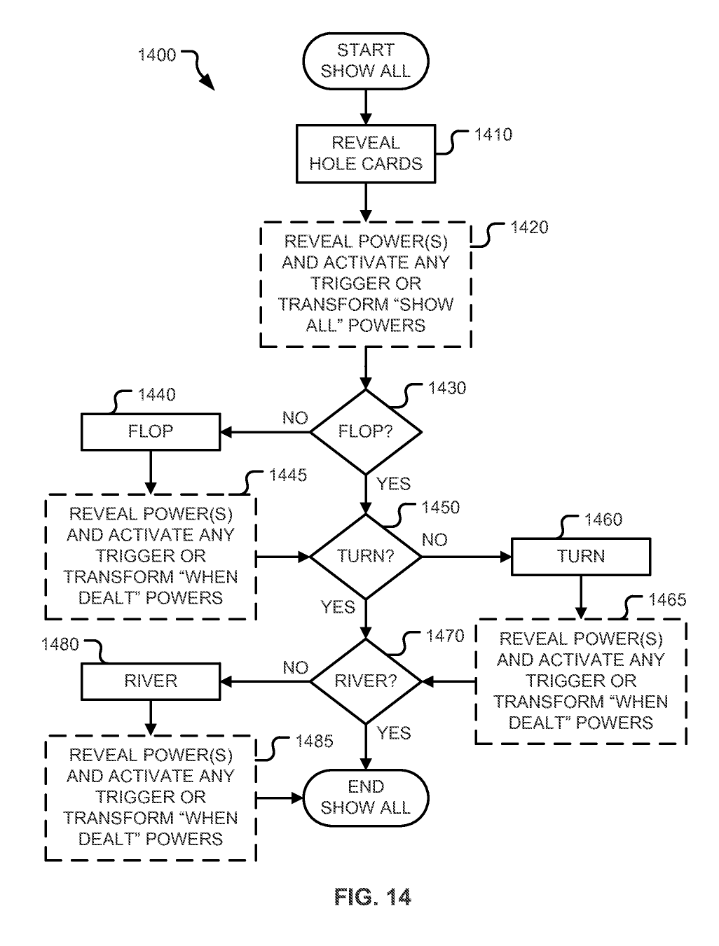

When the decision in decision block 1020 is “YES,” in block 1025, the system 132 performs a method 1400 illustrated in FIG. 14. Next, in block 1030, the system 132 performs the method 1500 illustrated in FIG. 15. Then, the method 1000 terminates.

On the other hand, when the decision in decision block 1020 is “NO,” the system 132 advances to block 1070.

In block 1070, the system 132 deals and reveals the community flop cards 321-323 (see FIG. 3B).

In block 1075, the system 132 reveals any powers associated with any of the remaining players and the revealed flop cards to those of the players 120 associated with the powers. Such powers may also be revealed to the other players depending upon when the relevant event indicator 284 of each power indicates the power is to be revealed to the other players. Then, the system 132 activates any such powers triggered by a “when dealt” event and/or performs any transforms that occur when a “when dealt” event occurs. Referring to FIG. 2, the power effect handler 184 may activate any such powers and implement their effects.

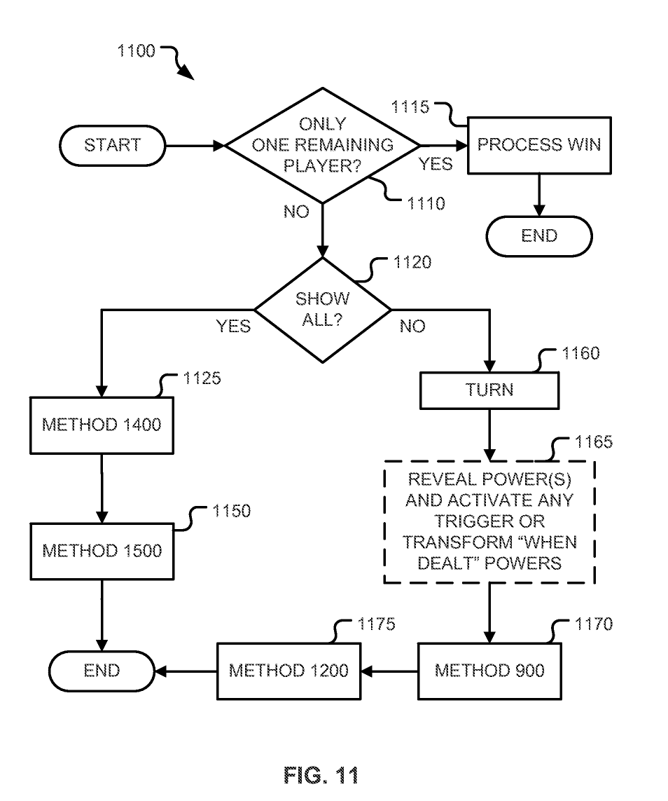

Returning to FIG. 10, in block 1080, the system 132 performs the method 900 for a post-flop round of betting. Then, in block 1085, the system 132 performs a method 1100 illustrated in FIG. 11. After block 1085, the method 1000 terminates.

FIG. 11 is a flow diagram of the method 1100 performed by the system 132 after the flop cards have been dealt and the method 900 has been performed for the second time in the hand. In decision block 1110, the system 132 determines whether only a single player remains in the hand.

The decision in decision block 1110 is “YES” when the system 132 determines only a single player remains in the hand. This occurs when all of the players except one indicated in block 940 of the method 900 (see FIG. 9) that they had decided to fold. The decision in decision block 1110 is “NO” when the system 132 determines more than one player remains in the hand.

When the decision in decision block 1110 is “YES,” in block 1115, the system 132 determines the remaining player is the winner and awards the winner the funds stored in the pot. Then, the method 1100 terminates.

On the other hand, when the decision in decision block 1110 is “NO,” the system 132 advances to decision block 1120. In decision block 1120, the system 132 determines whether the hole cards should be shown to all of the players 120. The decision in decision block 1120 is “YES” when the system 132 determines the hole cards should be shown to all of the players 120. This occurs when all of the remaining players except at most one are “all in.” In other words, no more betting can occur. The decision in decision block 1120 is “NO” when the system 132 determines the hole cards should not be shown to all of the players 120. This occurs when two or more of the remaining players are not “all in” and, therefore, more betting (e.g., in a side pot) can occur.

When the decision in decision block 1120 is “YES,” in block 1125, the system 132 performs the method 1400 illustrated in FIG. 14. Next, in block 1150, the system 132 performs the method 1500 illustrated in FIG. 15. Then, the method 1100 terminates.

On the other hand, when the decision in decision block 1120 is “NO,” the system 132 advances to block 1160.

In block 1160, the system 132 deals and reveals the community turn card 324 (see FIG. 3B).

In optional block 1165, the system 132 reveals any powers associated with any of the remaining players and the revealed turn card 324 (see FIG. 3B) to those of the players 120 associated with the powers. Such powers may also be revealed to the other players depending upon when the relevant event indicator 284 of each power indicates the power is to be revealed to the other players. Then, the system 132 activates any such powers triggered by a “when dealt” event and/or performs any transforms that occur when a “when dealt” event occurs. Referring to FIG. 2, the power effect handler 184 may activate any such powers and implement their effects.

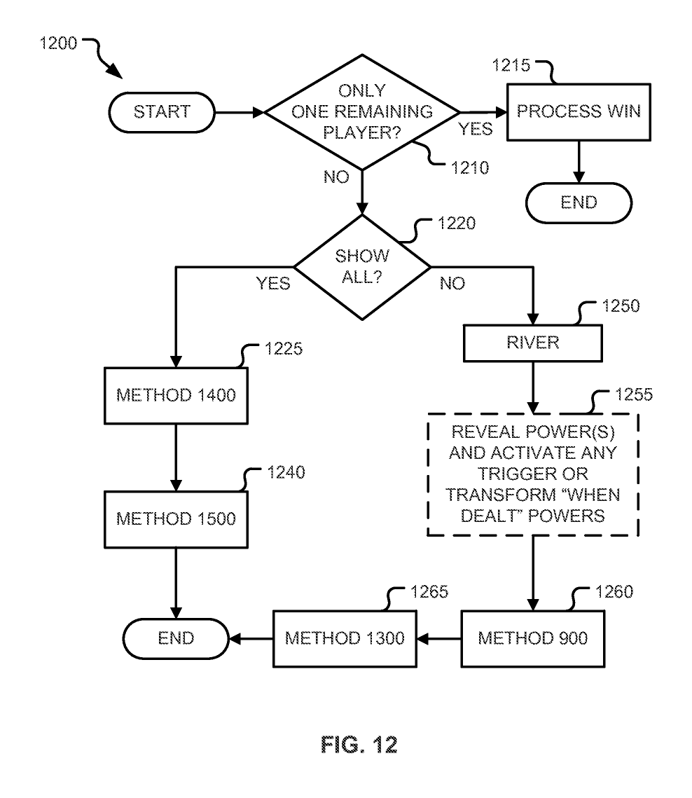

Returning to FIG. 11, in block 1170, the system 132 performs the method 900 for a post-turn round of betting. Then, in block 1175, the system 132 performs a method 1200 illustrated in FIG. 12. After block 1175, the method 1100 terminates.

FIG. 12 is a flow diagram of the method 1200 performed by the system 132 after the turn card 324 (see FIG. 3B) has been dealt and the method 900 has been performed for the third time in the hand. In decision block 1210, the system 132 determines whether only a single player remains in the hand.

The decision in decision block 1210 is “YES” when the system 132 determines only a single player remains in the hand. This occurs when all of the players except one indicated in block 940 of the method 900 (see FIG. 9) that they had decided to fold. The decision in decision block 1210 is “NO” when the system 132 determines more than one player remains in the hand.

When the decision in decision block 1210 is “YES,” in block 1215, the system 132 determines the remaining player is the winner and awards the winner the funds stored in the pot. Then, the method 1200 terminates.

On the other hand, when the decision in decision block 1210 is “NO,” the system 132 advances to decision block 1220. In decision block 1220, the system 132 determines whether the hole cards should be shown to all of the players 120. The decision in decision block 1220 is “YES” when the system 132 determines the hole cards should be shown to all of the players 120. This occurs when all of the remaining players except at most one are “all in.” In other words, no more betting can occur. The decision in decision block 1220 is “NO” when the system 132 determines the hole cards should not be shown to all of the players 120. This occurs when two or more of the remaining players are not “all in” and, therefore, more betting (e.g., in a side pot) can occur.

When the decision in decision block 1220 is “YES,” in block 1225, the system 132 performs the method 1400 illustrated in FIG. 14. Next, in block 1240, the system 132 performs the method 1500 illustrated in FIG. 15. Then, the method 1200 terminates.

On the other hand, when the decision in decision block 1220 is “NO,” the system 132 advances to block 1250.

In block 1250, the system 132 deals and reveals the community river card 325 (see FIG. 3B).

In optional block 1255, the system 132 reveals any powers associated with any of the remaining players and the revealed river card 325 (see FIG. 3B) to those of the players 120 associated with the powers. Such powers may also be revealed to the other players depending upon when the relevant event indicator 284 of each power indicates the power is to be revealed to the other players. Then, the system 132 activates any such powers triggered by a “when dealt” event and/or performs any transforms that occur when a “when dealt” event occurs. Referring to FIG. 2, the power effect handler 184 may activate any such powers and implement their effects.

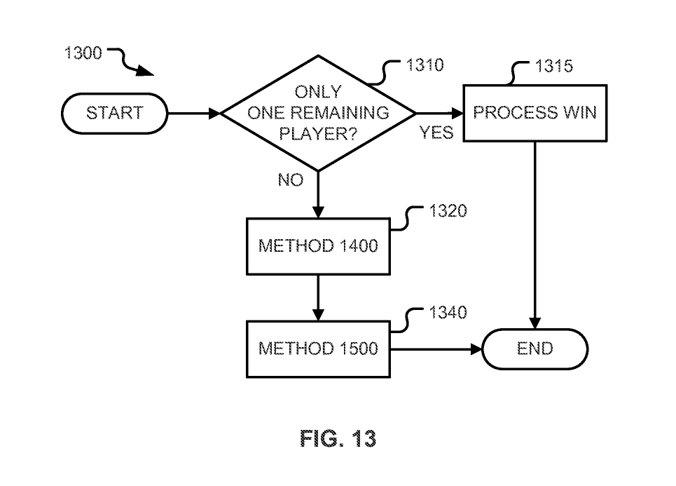

Returning to FIG. 12, in block 1260, the system 132 performs the method 900 for a post-river round of betting. Then, in block 1265, the system 132 performs a method 1300 illustrated in FIG. 13. After block 1265, the method 1200 terminates.

FIG. 13 is a flow diagram of the method 1300 performed by the system 132 after the river card has been dealt and the method 900 has been performed for the fourth time in the hand. In decision block 1310, the system 132 determines whether only a single player remains in the hand.

The decision in decision block 1310 is “YES” when the system 132 determines only a single player remains in the hand. This occurs when all of the players except one indicated in block 940 of the method 900 (see FIG. 9) that they had decided to fold. The decision in decision block 1310 is “NO” when the system 132 determines more than one player remains in the hand.

When the decision in decision block 1310 is “YES,” in block 1315, the system 132 determines the remaining player is the winner and awards the winner the funds stored in the pot. Then, the method 1300 terminates.

When the decision in decision block 1310 is “NO,” in block 1320, the system 132 performs the method 1400 illustrated in FIG. 14. Next, in block 1340, the system 132 performs the method 1500 illustrated in FIG. 15. Then, the method 1300 terminates.

FIG. 14 is a flow diagram of the method 1400 performed by the system 132. In block 1410, the system 132 displays all of the hole cards held by the remaining players to all of the players 120.

In block 1420, the system 132 triggers any powers that are triggered by the occurrence of a “show all” event. Referring to FIG. 2, the power effect handler 184 may activate any such powers and implement their effects. The system 132 also reveals all of the powers associated with the revealed cards to those of the players 120 associated with the powers. Such powers may also be revealed to the other players depending upon when the relevant event indicator 284 of each power indicates the power is to be revealed to the other players.

Returning to FIG. 14, in decision block 1430, the system 132 determines whether it has already dealt the community flop cards 321-323 (see FIG. 3B). The decision in decision block 1430 is “YES” when the system 132 determines it has already dealt the community flop cards 321-323 (see FIG. 3B). On the other hand, the decision in decision block 1430 is “NO” when the system 132 determines it has not yet dealt the community flop cards 321-323 (see FIG. 3B).

When the decision in decision block 1430 is “NO,” in block 1440, the system 132 deals and reveals the community flop cards 321-323 (see FIG. 3B). Then, in block 1445, the system 132 reveals any powers associated with the revealed flop card and any of the remaining players to those of the players 120 associated with the powers. Such powers may also be revealed to the other players depending upon when the relevant event indicator 284 of each power indicates the power is to be revealed to the other players. Then, the system 132 activates any such powers triggered by a “when dealt” event and/or performs any transforms that occur when a “when dealt” event occurs. Referring to FIG. 2, the power effect handler 184 may activate any such powers and implement their effects. Then, returning to FIG. 14, the system 132 advances to decision block 1450.

When the decision in decision block 1430 is “YES,” the system advances to decision block 1450.

In decision block 1450, the system 132 determines whether it has already dealt the community turn card 324 (see FIG. 3B). The decision in decision block 1450 is “YES” when the system 132 determines it has already dealt the community turn card 324 (see FIG. 3B). On the other hand, the decision in decision block 1450 is “NO” when the system 132 determines it has not yet dealt the community turn card 324 (see FIG. 3B).

When the decision in decision block 1450 is “NO,” in block 1460, the system 132 deals and reveals the community turn card 324 (see FIG. 3B). Then, in block 1465, the system 132 reveals any powers associated with the revealed turn card and any of the remaining players to those of the players 120 associated with the powers. Such powers may also be revealed to the other players depending upon when the relevant event indicator 284 of each power indicates the power is to be revealed to the other players. Then, the system 132 activates any such powers triggered by a “when dealt” event and/or performs any transforms that occur when a “when dealt” event occurs. Referring to FIG. 2, the power effect handler 184 may activate any such powers and implement their effects. Then, referring to FIG. 14, the system advances to decision block 1470.

When the decision in decision block 1450 is “YES,” the system advances to decision block 1470.

In decision block 1470, the system 132 determines whether it has already dealt the community river card 325 (see FIG. 3B). The decision in decision block 1470 is “YES” when the system 132 determines it has already dealt the community river card 325 (see FIG. 3B). On the other hand, the decision in decision block 1470 is “NO” when the system 132 determines it has not yet dealt the community river card 325 (see FIG. 3B).

When the decision in decision block 1470 is “NO,” in block 1480, the system 132 deals and reveals the community river card 325 (see FIG. 3B). Then, in block 1465, the system 132 reveals any powers associated with the revealed river card and any of the remaining players to those of the players 120 associated with the powers. Such powers may also be revealed to the other players depending upon when the relevant event indicator 284 of each power indicates the power is to be revealed to the other players. Then, the system 132 activates any such powers triggered by a “when dealt” event and/or performs any transforms that occur when a “when dealt” event occurs. Referring to FIG. 2, the power effect handler 184 may activate any such powers and implement their effects. Then, returning to FIG. 14, the method 1400 terminates.

When the decision in decision block 1470 is “YES,” the method 1400 terminates.

FIG. 15 is a flow diagram of the method 1500 performed by the system 132. In block 1510, the system 132 triggers any powers that are triggered by the occurrence of a “showdown” event. Referring to FIG. 2, the power effect handler 184 may activate any such powers and implement their effects.

Returning to FIG. 15, in block 1520, the system 132 identifies each remaining player's best five card hand based on the player's hole cards, the community flop cards 321-323 (see FIGS. 3B and 3D), the community turn card 324 (see FIGS. 3B and 3D), and the community river card 325 (see FIGS. 3B and 3D).

In block 1530, the system 132 identifies the winner based on the players' best hands. Referring to FIG. 2, the hand evaluator 186 may identity each remaining player's best five card hand and identity the winner.

Returning to FIG. 15, in block 1540, the system 132 awards at least some of the funds stored in the pot to the winner. For example, the winner is awarded all of the funds stored in the pot when (a) the winner was not “all in,” or (b) the winner was “all in” but the bet level was never higher than the winner's previous bet amount.

On the other hand, the winner is awarded only a first portion of the funds stored in the pot (that is less than the total funds stored in the pot) when the winner was “all in” but additional bets were made during the hand that the winner, being “all in,” could not match. In this situation, at least one other (losing) player contributed more funds to the pot than the winner contributed. A second portion of the funds stored in the pot includes those funds contributed by each of the other (losing) players that exceed the contribution made by the winner. The second portion is not awarded to the winner. For example, if the losing players P1 and P2 each contributed $10 to the pot, and the winner player P3 was “all in” but contributed only $4 to the pot, the winner player P3 would be awarded $12 (which includes the player P3's $4 contribution to the pot, and matching amounts from the funds contributed to the pot by the players P1 and P2). In this example, the first portion of the funds stored in the pot is $12, and the second portion is $12. The second portion is commonly referred to as a “side pot.”

At this point, the winner no longer remains in the hand, and the system 132 returns to block 1530 to select a new winner from amongst the remaining players. Then, the system 132 returns to block 1540 where the system 132 awards at least some of the funds of the side pot to the new winner. Blocks 1530 and 1540 may be repeated until all of the funds stored in the pot have been awarded.

Then, the method 1500 terminates.

### Alternative Embodiment

In an alternate embodiment, instead of the plurality of default game rules 215 being the rules of Texas hold'em, the rules of video poker are used. Thus, this embodiment will be referred to as the video poker embodiment. As is apparent to those of ordinary skill in the art, video poker is typically played by a single player against a game device (e.g., the server computer device 136, a video game device, and the like).

FIG. 16 is a flow diagram of a method 1600 implementing the video poker embodiment. The method 1600 is performed by the system 132 (see FIGS. 1 and 2). In first block 1610, the system 132 identifies one or more powers for use during the game.

In next block 1620, the system 132 assigns an amount of money or quantity of chips to the player to use to place bets during the game. For ease of illustration, the amount assigned to the player will be described as being stored in an account associated with (or owned by) the player. The amount stored in the account may be displayed to the player in an account balance indicator (like the account balance indicators 330 and 332 depicted in FIG. 3B).

In block 1630, the system 132 instantiates the card deck 310 (see FIG. 3B) of cards.

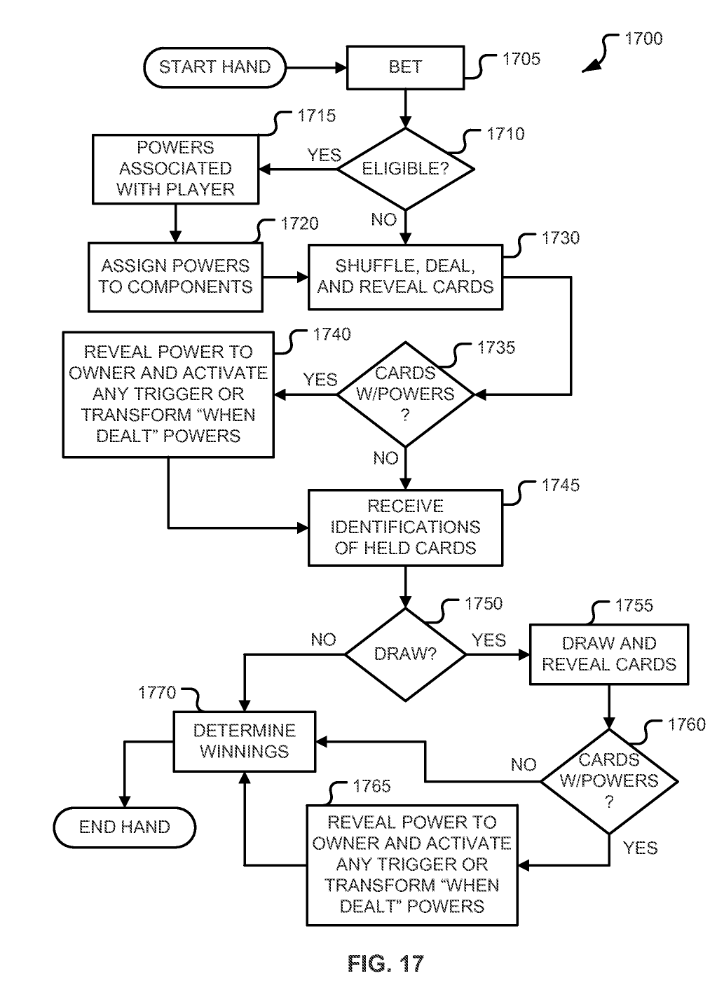

In next block 1640, a method 1700 depicted in FIG. 17 is performed.

After block 1640, in decision block 1680, the system 132 determines whether the player would like to play another hand of the game. For example, in decision block 1680, the system 132 may query the user and receive a response indicating whether the player would like to play another hand. The decision in decision block 1680 is “YES” when the system 132 determines the player would like to play another hand of the game. On the other hand, the decision in decision block 1680 is “NO” when the system 132 determines the player would not like to play another hand of the game.

When the decision in decision block 1680 is “YES,” the system 132 returns to block 1640 to start a new hand.

When the decision in decision block 1680 is “NO,” the method 1600 terminates.

FIG. 17 is a flow diagram of the method 1700 of implementing a hand of the video poker embodiment. The method 1700 is performed by the system 132 (see FIGS. 1 and 2).

In first block 1705, the system 132 may receive a bet amount from the user. The system 132 subtracts the bet amount from the account associated with (or owned by) the player. The account balance indicator (like the account balance indicators 330 and 332 depicted in FIG. 3B) may be updated to reflect the subtraction of the bet amount from the player's account.

Then, in decision block 1710, the system 132 determines whether the player is eligible for any of the powers selected in block 1610 of the method 1600 depicted in FIG. 16. Returning to FIG. 17, the decision in decision block 1710 is “YES,” when one or more predefined criteria are satisfied. The criteria may include the bet amount being equal to or greater than a threshold amount. The decision in decision block 1710 is “NO,” when the predefined criteria have not been satisfied.

When the decision in decision block 1710 is “YES,” in block 1715, the system 132 associates one or more powers with the player. The powers associated with the player may be selected by the player or assigned automatically by the system 132.

In block 1720, the system 132 assigns the power(s) associated with the player to at least some of the game component objects 200 (e.g., cards). The block 1720 may be substantially identical to the block 750 of the method 700 (depicted in FIG. 7). Then, the system 132 advances to block 1730.

When the decision in decision block 1710 is “NO,” the system 132 advances to block 1730.

In block 1730, the system 132 shuffles the cards, deals five cards to the player, and reveals the dealt cards. If betting has not yet occurred (e.g., in block 1705), the player may be given the opportunity to place a bet before the cards are dealt.

Then, in decision block 1735, the system 132 determines whether any of the cards dealt in block 1730 had powers assigned to them in block 1720. The decision in decision block 1735 is “YES” when the system 132 determines a power was assigned to one or more of the cards dealt in block 1730. Otherwise, the decision in decision block 1735 is “NO.”

When the decision in decision block 1735 is “YES,” in block 1740, the system 132 reveals the power(s) to the player. For example, each power associated with one of the dealt cards may be identified by a visual indicator (e.g., the visual indicator 410 depicted in FIG. 3C) displayed to the player indicating that the power is associated with the game component object representing the card.

The system 132 activates any powers triggered by a “when dealt” event and/or performs any transforms that occur after a “when dealt” event. Referring to FIG. 2, the power effect handler 184 may activate any such powers and implement their effects. Returning to FIG. 17, the system 132 advances to block 1745.

When the decision in decision block 1735 is “NO,” the system 132 advances to block 1745.

In block 1745, the system 132 receives identifications from the user indicating which of the five cards the player wishes to keep (or hold). Any cards not identified as being held are discarded.

In decision block 1750, the system 132 determines whether any replacement cards need to be dealt to the player. In other words, the system 132 determines whether any cards need to be drawn. A replacement card needs to be drawn for each card discarded in block 1745. Thus, the decision in decision block 1750 is “YES” when the player has decided to discard one or more cards. Otherwise, the decision in decision block 1750 is “NO.”

When the decision in decision block 1750 is “YES,” in block 1755, the system 132 draws replacement cards for the player, and reveals the newly drawn cards. Then, the system 132 advances to decision block 1760.

In decision block 1760, the system 132 determines whether any of the cards drawn in block 1755 had powers assigned to them in block 1720. The decision in decision block 1755 is “YES” when the system 132 determines one or more of the cards drawn in block 1755 had powers assigned to them. Otherwise, the decision in decision block 1760 is “NO.”

When the decision in decision block 1760 is “YES,” in block 1765, the system 132 reveals the power(s) to the player. For example, each power associated with one of the drawn cards may be identified by a visual indicator (e.g., the visual indicator 410 depicted in FIG. 3C) displayed to the player indicating that the power is associated with the game component object representing the card.

The system 132 activates any powers triggered by a “when dealt” event and/or performs any transforms that occur after a “when dealt” event. Referring to FIG. 2, the power effect handler 184 may activate any such powers and implement their effects. Returning to FIG. 17, the system 132 advances to block 1770.

When the decision in decision block 1760 is “NO,” the system 132 advances to block 1770.

In block 1770, the system 132 determines how much the player has won based on the player's hand. As is appreciated by those of ordinary skill in the art, the player's winnings may be determined by looking up the player's hand in a payout table. Any winnings are added to the player's account and the account balance indicator (like the account balance indicators 330 and 332 depicted in FIG. 3B) may be updated to reflect the addition of the winnings to the player's account.

Then, the method 1700 terminates.

### Computing Device

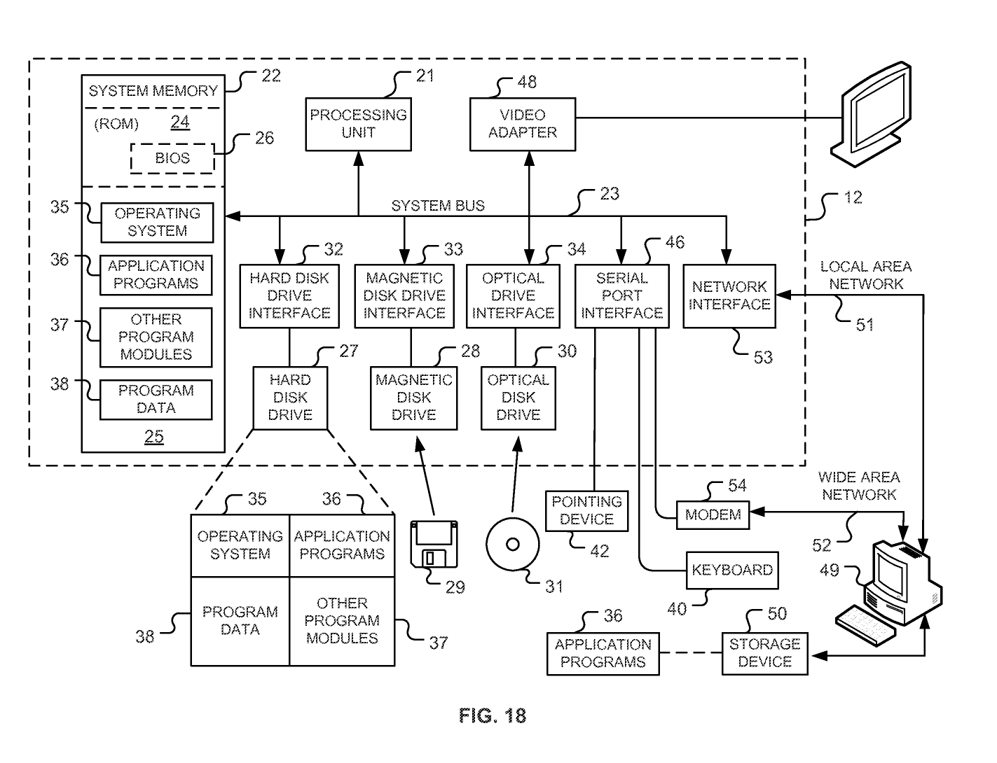

FIG. 18 is a diagram of hardware and an operating environment in conjunction with which implementations of the one or more computing devices of the system 100 may be practiced. The description of FIG. 18 is intended to provide a brief, general description of suitable computer hardware and a suitable computing environment in which implementations may be practiced. Although not required, implementations are described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that implementations may be practiced with other computer system configurations, including hand-held devices, multiprocessor systems, microprocessor-based or programmable consumer electronics, network PCs, minicomputers, mainframe computers, and the like. Implementations may also be practiced in distributed computing environments where tasks are performed by remote processing devices that are linked through a communications network. In a distributed computing environment, program modules may be located in both local and remote memory storage devices.

The exemplary hardware and operating environment of FIG. 18 includes a general-purpose computing device in the form of the computing device 12. Each of the computing devices of FIG. 1 (including the client computing device 121-123, the server computer device 136, and any computing device(s) implementing the game database 134) may be substantially identical to the computing device 12. By way of non-limiting examples, the computing device 12 may be implemented as a laptop computer, a tablet computer, a web enabled television, a personal digital assistant, a game console, a smartphone, a mobile computing device, a cellular telephone, a desktop personal computer, and the like.

The computing device 12 includes a system memory 22, the processing unit 21, and a system bus 23 that operatively couples various system components, including the system memory 22, to the processing unit 21. There may be only one or there may be more than one processing unit 21, such that the processor of computing device 12 includes a single central-processing unit (“CPU”), or a plurality of processing units, commonly referred to as a parallel processing environment. When multiple processing units are used, the processing units may be heterogeneous. By way of a non-limiting example, such a heterogeneous processing environment may include a conventional CPU, a conventional graphics processing unit (“GPU”), a floating-point unit (“FPU”), combinations thereof, and the like.

The computing device 12 may be a conventional computer, a distributed computer, or any other type of computer.

The system bus 23 may be any of several types of bus structures including a memory bus or memory controller, a peripheral bus, and a local bus using any of a variety of bus architectures. The system memory 22 may also be referred to as simply the memory, and includes read only memory (ROM) 24 and random access memory (RAM) 25. A basic input/output system (BIOS) 26, containing the basic routines that help to transfer information between elements within the computing device 12, such as during start-up, is stored in ROM 24. The computing device 12 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules, and other data for the computing device 12. It should be appreciated by those skilled in the art that any type of computer-readable media which can store data that is accessible by a computer, such as magnetic cassettes, flash memory cards, solid state memory devices (“SSD”), USB drives, digital video disks, Bernoulli cartridges, random access memories (RAMs), read only memories (ROMs), and the like, may be used in the exemplary operating environment. As is apparent to those of ordinary skill in the art, the hard disk drive 27 and other forms of computer-readable media (e.g., the removable magnetic disk 29, the removable optical disk 31, flash memory cards, SSD, USB drives, and the like) accessible by the processing unit 21 may be considered components of the system memory 22.

A number of program modules may be stored on the hard disk drive 27, magnetic disk 29, optical disk 31, ROM 24, or RAM 25, including the operating system 35, one or more application programs 36, other program modules 37, and program data 38. A user (e.g., one of the players 120) may enter commands and information into the computing device 12 through input devices such as a keyboard 40 and pointing device 42. Other input devices (not shown) may include a microphone, joystick, game pad, satellite dish, scanner, touch sensitive devices (e.g., a stylus or touch pad), video camera, depth camera, or the like. These and other input devices are often connected to the processing unit 21 through a serial port interface 46 that is coupled to the system bus 23, but may be connected by other interfaces, such as a parallel port, game port, a universal serial bus (USB), or a wireless interface (e.g., a Bluetooth interface). A monitor 47 or other type of display device is also connected to the system bus 23 via an interface, such as a video adapter 48. In addition to the monitor, computers typically include other peripheral output devices (not shown), such as speakers, printers, and haptic devices that provide tactile and/or other types of physical feedback (e.g., a force feedback game controller).

The input devices described above are operable to receive user input and selections. Together the input and display devices may be described as providing a user interface. The user interface 154 (see FIG. 2) may be implemented using at least some of these input and display devices. Further, the interactive graphical user interface 157 (see FIGS. 3B and 3D) may be displayed by the monitor 47 or other type of display devices.

The computing device 12 may operate in a networked environment using logical connections to one or more remote computers, such as remote computer 49. These logical connections are achieved by a communication device coupled to or a part of the computing device 12 (as the local computer). Implementations are not limited to a particular type of communications device. The remote computer 49 may be another computer, a server, a router, a network PC, a client, a memory storage device, a peer device or other common network node, and typically includes many or all of the elements described above relative to the computing device 12. The remote computer 49 may be connected to a memory storage device 50. The logical connections depicted in FIGS. 1 and 2 include a local-area network (LAN) 51 and a wide-area network (WAN) 52. Such networking environments are commonplace in offices, enterprise-wide computer networks, intranets and the Internet. The network 130 (see FIG. 1) may be implemented using one or more of the LAN 51 or the WAN 52 (e.g., the Internet).

Those of ordinary skill in the art will appreciate that a LAN may be connected to a WAN via a modem using a carrier signal over a telephone network, cable network, cellular network, or power lines. Such a modem may be connected to the computing device 12 by a network interface (e.g., a serial or other type of port). Further, many laptop computers may connect to a network via a cellular data modem.

When used in a LAN-networking environment, the computing device 12 is connected to the local area network 51 through a network interface or adapter 53, which is one type of communications device. When used in a WAN-networking environment, the computing device 12 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computing device 12, or portions thereof, may be stored in the remote computer 49 and/or the remote memory storage device 50. It is appreciated that the network connections shown are exemplary and other means of and communications devices for establishing a communications link between the computers may be used.

The computing device 12 and related components have been presented herein by way of particular example and also by abstraction in order to facilitate a high-level view of the concepts disclosed. The actual technical design and implementation may vary based on particular implementation while maintaining the overall nature of the concepts disclosed.

In some embodiments, the system memory 22 stores computer executable instructions that when executed by one or more processors cause the one or more processors to perform all or portions of one or more of the methods (including the methods 600-1700 illustrated in FIGS. 6-17, respectively) described above. Such instructions may be stored on one or more non-transitory computer-readable media.

In some embodiments, the system memory 22 stores computer executable instructions that when executed by one or more processors cause the one or more processors to generate the interactive graphical user interface 157 (see FIGS. 3B and 3D) described above. Such instructions may be stored on one or more non-transitory computer-readable media.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A computer-implemented method comprising:
associating, in a computing system, a power with a player of a digital game, the power being inactive when associated with the player, the digital game comprising a plurality of game rules, a plurality of game elements, and a plurality of game component objects each representing a different one of the plurality of game elements;
automatically assigning, in the computing system, the inactive power to a selected one of the plurality of game component objects;
determining, by the computing system, that an activation event has occurred;
activating, by the computing system, the power after the computing system determines that the activation event has occurred, the activated power introducing at least one exception to the plurality of rules thereby modifying the game; and
determining, by the computing system, whether the player has won the modified game.

2. The method of claim 1, wherein the inactive power is automatically assigned to the selected game component object without any input from the player related to the assignment.

3. The method of claim 1, wherein the at least one exception to the plurality of rules transforms a particular one of the plurality of elements into a new element or a different one of the plurality of elements.

4. The method of claim 1, wherein the plurality of elements are cards of standard playing card deck comprising 52 playing cards, and
the at least one exception to the plurality of rules dictates that a particular card be dealt to the player.

5. The method of claim 1, wherein the determination that the activation event has occurred occurs while the player is playing the digital game.

6. The method of claim 1, further comprising:
directing, by the computing system, a display device to display a visual representation of the game element represented by the selected game component object to the player, the visual representation including a visual indicator indicating that the power is assigned to the game element represented by the selected game component object.

7. The method of claim 6, wherein the player is a first player and the game is also being played by a second different player, and
the visual indicator indicating that the power is associated with the selected game component object is not displayed to the second player.

8. The method of claim 6, wherein the visual indicator indicates whether the power is active or inactive.

9. The method of claim 6, wherein the plurality of elements are cards of standard playing card deck comprising 52 playing cards,
the activation event is the dealing of the card represented by the selected game component object, and
the visual representation of the card represented by the selected game component object is displayed to the player after the card has been dealt to the player.

10. The method of claim 6, wherein the computing system is a game device, and the display device is connected to and collocated with the game device.

11. The method of claim 6, wherein the computing system is a server computing system, and the display device is connected to a remote client computing device connected to the server computer system by a network.

12. The method of claim 1, wherein the activation event comprises an action occurring with respect to the game element represented by the selected game component object, and the action occurs while the player is playing the digital game.

13. The method of claim 1, wherein the activation event comprises receiving an indication from the player to activate the power.

14. The method of claim 1, wherein the computing system does not reveal to the player which of the plurality of game component objects is the selected game component object until after the activation event has occurred.

15. The method of claim 1, wherein the game is a Texas hold'em variant of poker, and the plurality of elements are cards of standard playing card deck comprising 52 playing cards.

16. The method of claim 1, wherein the plurality of elements are cards of standard playing card deck comprising 52 playing cards, each of the 52 cards comprising a rank and a suit, and
the activated power transforms a particular one of the plurality of game elements into a different one of the plurality of game elements by changing at least one of the rank and the suit of the particular element.

17. A game device comprising one or more processors and a memory storing a plurality of game rules for a digital game, a plurality of game elements, a plurality of game component objects each representing a different one of the plurality of game elements, and computer executable instructions that when executed by the one or more processors cause the game device to:
associate an inactive power with a player of the digital game;
automatically assign the inactive power to a selected one of the plurality of game component objects;
determine that an activation event has occurred;
activate the power after having determined that the activation event has occurred, the activated power introducing at least one exception to the plurality of rules thereby modifying the game; and
determine whether the player has won the modified game.

18. The game device of claim 17, wherein the inactive power is automatically assigned to the selected game component object without any input from the player related to the assignment.

19. The game device of claim 17, further comprising:
a display device, wherein when the computer executable instructions are executed by the one or more processors, the computer executable instructions cause the game device to display a visual representation of the game element represented by the selected game component object on the display device, the visual representation including a visual indicator indicating that the power is assigned to the game element represented by the selected game component object.

20. The game device of claim 19, wherein the player is a first player and the game is also being played by a second different player, and
the visual indicator indicating that the power is associated with the selected game component object is not displayed to the second player.

21. The game device of claim 20, wherein the visual indicator indicates whether the power is active or inactive.

22. The game device of claim 17, wherein the game device does not reveal to the player which of the plurality of game component objects is the selected game component object until after the activation event has occurred.
